(19) United States
(12) Patent Application Publication
(10) Pub. No.: US 2016/0253094 A1
(43) Pub. Date: Sep. 1, 2016

(54) INFORMATION PROCESSING DEVICE, DATA CACHE DEVICE, INFORMATION PROCESSING METHOD, AND DATA CACHING METHOD

(71) Applicant: NEC CORPORATION, Minato-ku, Tokyo (JP)

(72) Inventors: HIROAKI INOUE, Tokyo (JP); TAKASHI TAKENAKA, Tokyo (JP)

(73) Assignee: NEC Corporation, Minato-ku, Tokyo (JP)

(21) Appl. No.: 15/030,965

(22) PCT Filed: Oct. 20, 2014
(86) PCT No.: PCT/JP2014/005311

§ 371 Date: Apr. 21, 2016

(30) Foreign Application Priority Data
Nov. 1, 2013 (JP) 2013-228291
Apr. 11, 2014 (JP) 2014-082152

(51) Int. Cl. G06F 3/06; H04L 29/08; G06F 12/08

(52) U.S. Cl. CPC G06F 3/061; G06F 3/0659; G06F 3/0673; G06F 12/0813; H04L 67/2842; H04L 67/1097; G06F 2212/1016; G06F 2212/154

(57) ABSTRACT

An information processing apparatus includes: a data cache apparatus including a cache memory; and a management apparatus including a large capacity memory whose capacity is larger than that of the cache memory, wherein the data cache apparatus includes a data cache control unit configured to control data in a predetermined condition stored in the cache memory to be located in the large capacity memory when a read request or a write request is received from outside the information processing apparatus, and wherein when the received request is a write request, the data cache control unit writes data to be written to the cache memory in accordance with the write request, and when the request is a read request, the data cache control unit writes data read in accordance with the read request to the cache memory.

### TECHNICAL FIELD

The present invention relates to an information processing apparatus, a data cache apparatus, an information processing method, and a data caching method.

### BACKGROUND ART

In recent years, demand for an information processing apparatus which is capable of dealing with a large amount of data and which processes data at a high speed is increasing. However, a database product in which data is stored in an external storage apparatus such as a hard disk suffers from a slow disk access. Therefore, in recent years, an information processing apparatus (an in-memory database system such as a memcached) in which a high speed data processing is performed by storing data not on a hard disk but on a memory such as a main memory is utilized.

For example, PTL 1 describes a method for determining which mirror site of a content provider should receive a content request of an end user in a load distribution system.

PTL 2 describes a method in which, when a cache server is installed on an overall network and a document request can be executed at an intermediate node along a routing graph, the intermediate node returns a cache document to a client.

### CITATION LIST

### Patent Literature

PTL 1: Japanese Patent No. 4690628
PTL 2: Japanese Unexamined Patent Application Publication (Translation of PCT Application) No. 2001-526814

### Non Patent Literature

NPL 1: Michaela Blott, Kimon Karras, Ling Liu, Kees Vissers, Jeremia Baer, Zsolt Istvan, “Achieving 10 Gbps Line-rate Key-value Stores with FPGAs”, HotCloud′13, San Jose, Calif., June 2013
NPL 2: John L. Hennessy, David A. Patterson, “Computer Architecture, Fifth Edition: A Quantitative Approach (The Morgan Kaufmann Series in Computer Architecture and Design)”, Morgan Kaufmann Publishers, September 2011

### SUMMARY OF INVENTION

### Technical Problem

An in-memory information processing apparatus which handles data on a memory provides with a data processing unit, for example, implemented in a central processing unit (CPU), which processes data by utilizing a large capacity memory in accordance with a read/write request input from a network. In some cases, an information processing apparatus whose speed is enhanced by the in-memory information processing apparatus contains the data processing unit in a device other than a CPU, which is different from a normal server. Examples of the device other than a CPU include a field programmable gate array (FPGA) and a many-core processor. Such an information processing apparatus processes a read/write request input from a network at a higher speed than a CPU (for example, NPL 1).

However, in the above-described configuration, the data processing unit is implemented on a board on which a special device is mounted, which is different from a normal server. As a result, due to limitations or the like of such a board, the amount of data which can be handled is limited to a small amount. Accordingly, a large amount of data cannot be handled in an in-memory fashion.

The methods of PTL 1 and 2 do not deal with data writing. In addition, an access protocol (uniform resource locator (URL) or the like) which is used when data is cached in the methods is different from that of a large capacity memory. Although a cache of a microprocessor (for example, NPL 2) is also known as a similar data location mechanism, an access protocol of a cache memory of a microprocessor is different from that of a large capacity memory.

Accordingly, an in-memory information processing apparatus has had issues in that it is difficult to handle a large capacity of data at a high speed.

The present invention has been made in consideration of the above-described issues, and an object of the present invention is to provide an information processing apparatus capable of handling a large capacity of data at a high speed.

### Solution to Problem

An information processing apparatus according to one exemplary aspect of the present invention includes: a data cache apparatus including a cache memory; and a management apparatus including a large capacity memory whose capacity is larger than that of the cache memory, wherein the data cache apparatus includes data cache control means for controlling data in a predetermined condition stored in the cache memory to be located in the large capacity memory when a read request or a write request is received from outside the information processing apparatus, and wherein when the received request is a write request, the data cache control means writes data to be written to the cache memory in accordance with the write request, and when the request is a read request, the data cache control means writes data read in accordance with the read request to the cache memory.

A data cache apparatus according to one exemplary aspect of the present invention includes a cache memory, is connected to a management apparatus including a large capacity memory whose capacity is larger than that of the cache memory, and includes data cache control means for controlling data in a predetermined condition stored in the cache memory to be located in the large capacity memory when a read request or a write request is received from outside the data cache apparatus and the management apparatus, whrein when the received request is a write request, the data cache control means writes data to be written to the cache memory in accordance with the write request, and when the request is a read request, the data cache control means writes data read in accordance with the read request to the cache memory.

An information processing method of an information processing apparatus including a data cache apparatus including a cache memory and a management apparatus including a large capacity memory whose capacity is larger than that of the cache memory according to one exemplary aspect of the present invention, includes: receiving a read request or a write request from outside the information processing apparatus; when the received request is a write request, controlling data in a predetermined condition stored in the cache memory to be located in the large capacity memory and further writing data to be written to the cache memory in accordance with the write request; and when the received request is a read request, controlling the data in the predetermined condition to be located in the large capacity memory and further writing data read in accordance with the read request to the cache memory.

A data caching method of a data cache apparatus which includes a cache memory and which is connected to a management apparatus including a large capacity memory whose capacity is larger than that of the cache memory according to one exemplary aspect of the present invention, includes: receiving a read request or a write request from outside the data cache apparatus and the management apparatus; when the received request is a write request, controlling data in a predetermined condition stored in the cache memory to be located in the large capacity memory and further writing data to be written to the cache memory in accordance with the write request; and when the received request is a read request, controlling the data in the predetermined condition to be located in the large capacity memory and further writing data read in accordance with the read request to the cache memory.

### Advantageous Effects of Invention

According to the present invention, a large capacity of data can be handled at a higher speed.

### BRIEF DESCRIPTION OF DRAWINGS

FIG. 1 is a block diagram illustrating one example of a hardware configuration of an information processing apparatus according to a first exemplary embodiment of the present invention.

FIG. 2 is a diagram illustrating one example of data structures of a read/write request and a read/write response.

FIG. 3 is a functional block diagram illustrating one example of a functional configuration of an accelerator of a data cache apparatus according to the first exemplary embodiment of the present invention.

FIG. 4 is a functional block diagram illustrating one example of a functional configuration of a data cache control unit according to the first exemplary embodiment of the present invention.

FIG. 5 is a diagram illustrating one example of a management table stored in a table storage unit according to the first exemplary embodiment of the present invention.

FIG. 6 is a flow chart illustrating one example of a processing flow of a data cache apparatus according to the first exemplary embodiment of the present invention.

FIG. 7 is a flow chart illustrating one example of a processing flow of a data cache apparatus when a write request or a read request is not a request which is handled in a data cache apparatus.

FIG. 8 is a flow chart illustrating one example of a processing flow of a data cache apparatus when a read request is a request which is handled in a data cache apparatus and data associated with the read request is present in a small capacity memory.

FIG. 9 is a flow chart illustrating one example of a processing flow of a data cache apparatus when a read request is a request which is handled in a data cache apparatus and data associated with the read request is not present in a small capacity memory.

FIG. 10 is a flow chart illustrating one example of a processing flow of a data cache apparatus when, in a case of FIG. 9, the size of a free space of the small capacity memory is smaller than the data length of data read by the above-described read request.

FIG. 11 is a flow chart illustrating one example of a processing flow of a data cache apparatus when a write request is a request which is handled in a data cache apparatus and data associated with the write request is present in a small capacity memory.

FIG. 12 is a flow chart illustrating one example of a processing flow of a data cache apparatus when a write request is a request which is handled in a data cache apparatus and data associated with the write request is not present in a small capacity memory.

FIG. 13 is a flow chart illustrating another example of a processing flow of a data cache apparatus when a write request is a request which is handled in a data cache apparatus and data associated with the write request is not present in a small capacity memory.

FIG. 14 is a block diagram illustrating one example of a hardware configuration of an information processing apparatus according to a second exemplary embodiment of the present invention.

FIG. 15 is a functional block diagram illustrating one example of a functional configuration of an accelerator of a data cache apparatus according to the second exemplary embodiment of the present invention.

FIG. 16 is a functional block diagram illustrating one example of a functional configuration of a data cache control unit according to the second exemplary embodiment of the present invention.

FIG. 17 is a diagram illustrating one example of a management table according to the second exemplary embodiment of the present invention.

FIG. 18 is a block diagram illustrating one example of a configuration of an information processing apparatus according to a third exemplary embodiment of the present invention.

FIG. 19 is a block diagram illustrating one example of a hardware configuration of an information processing apparatus according to a fourth exemplary embodiment of the present invention.

FIG. 20 is a functional block diagram illustrating one example of a functional configuration of the second accelerator of a data cache apparatus according to the fourth exemplary embodiment of the present invention.

FIG. 21 is a diagram illustrating one example of a processing flow of the second accelerator of a data cache apparatus according to the fourth exemplary embodiment of the present invention.

### DESCRIPTION OF EMBODIMENTS

### First Embodiment

In the following, a first exemplary embodiment of the present invention will be described in detail with reference to the accompanying drawings.

### (Information Processing Apparatus 100)

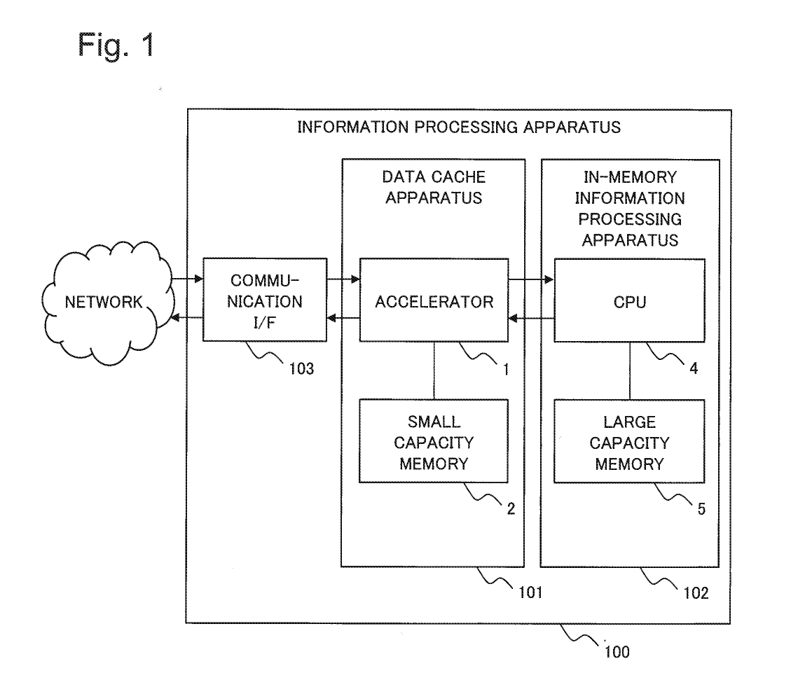

FIG. 1 is a block diagram illustrating one example of a hardware configuration of an information processing apparatus 100 according to a first exemplary embodiment of the present invention. As shown in FIG. 1, the information processing apparatus 100 includes a data cache apparatus 101, an in-memory information processing apparatus 102, and a communication interface (I/F) 103. The data cache apparatus 101 includes an accelerator 1 and a small capacity memory 2. The in-memory information processing apparatus 102 includes a central processing unit (CPU) 4, which is included in a general server, and a large capacity memory 5 whose capacity is larger than that of this small capacity memory 2. The in-memory information processing apparatus 102 in the exemplary embodiment is functioned as a database management server apparatus including the large capacity memory 5.

A communication I/F 103 receives a read/write request from a network and provides it to the accelerator 1. The communication I/F 103 also returns a read/write response to the read/write request provided from the accelerator 1 to the network.

The accelerator 1 is connected to the small capacity memory 2, and transmits and receives a read/write request of data to and from the CPU 4. The accelerator 1 is implemented by an FPGA, a many-core processor, or the like. The accelerator 1 receives a read/write request which is received by the communication I/F 103. The accelerator 1 also returns a read/write response to the communication I/F 103. A functional configuration of the accelerator 1 will be described with reference to another drawing.

The CPU 4 includes a data management unit equivalent to a so-called in-memory database management system which utilizes the large capacity memory 5. The data management unit of the CPU 4 receives a read/write request from the accelerator 1 and performs a corresponding process to the request. The CPU 4 then returns a read/write response to the accelerator 1. Since the CPU 4 according to the present exemplary embodiment is a general CPU, a detailed explanation thereof will be omitted.

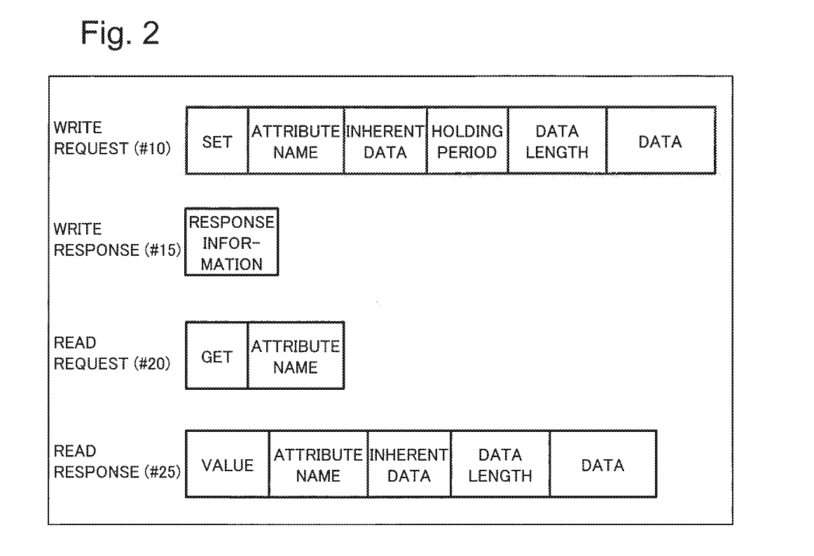

In the following, data structures of the read/write request and the read/write response will be described. FIG. 2 is a diagram illustrating one example of the data structures of the read/write request and the read/write response. As illustrated in FIG. 2, a write request #10 includes “SET” which is a request type, an attribute name, inherent data, a holding period, a data length, and data. The attribute name refers to data, and when data is stored in the small capacity memory 2 or the large capacity memory 5, the attribute name is unique information for specifying the data. The attribute name is represented by an identifier such as an ID (identifier).

Inherent data guarantees the uniqueness of a request. The holding period represents a period during which stored data is held. The data length is the length of data to be written. Hereinafter, data to be written is referred to as “write data”.

A write response #15 which is a response to the write request #10 includes response information. The response information is information representing whether writing by the write request #10 is normally finished or not.

The read request #20 includes “GET” which is a request type and an attribute name. A read response #25 which is a response to the read request #20 includes “VALUE” which is a response type, an attribute name corresponding to the read request #20 of the attribute name, inherent data, a data length, and data. The inherent data corresponds to the inherent data included in the write request #10 including the attribute name corresponding to the read request #20 of the attribute name.

Although the write request #10 and the read request #20 include only one attribute name, they may include a plurality of attribute names. In such a case, the read response #25 includes a plurality of responses for each attribute name.

The data structures of the write request #10, the write response #15, the read request #20, and the read response #25 as illustrated in FIG. 2 are one example, and not limited thereto.

(Accelerator 1)

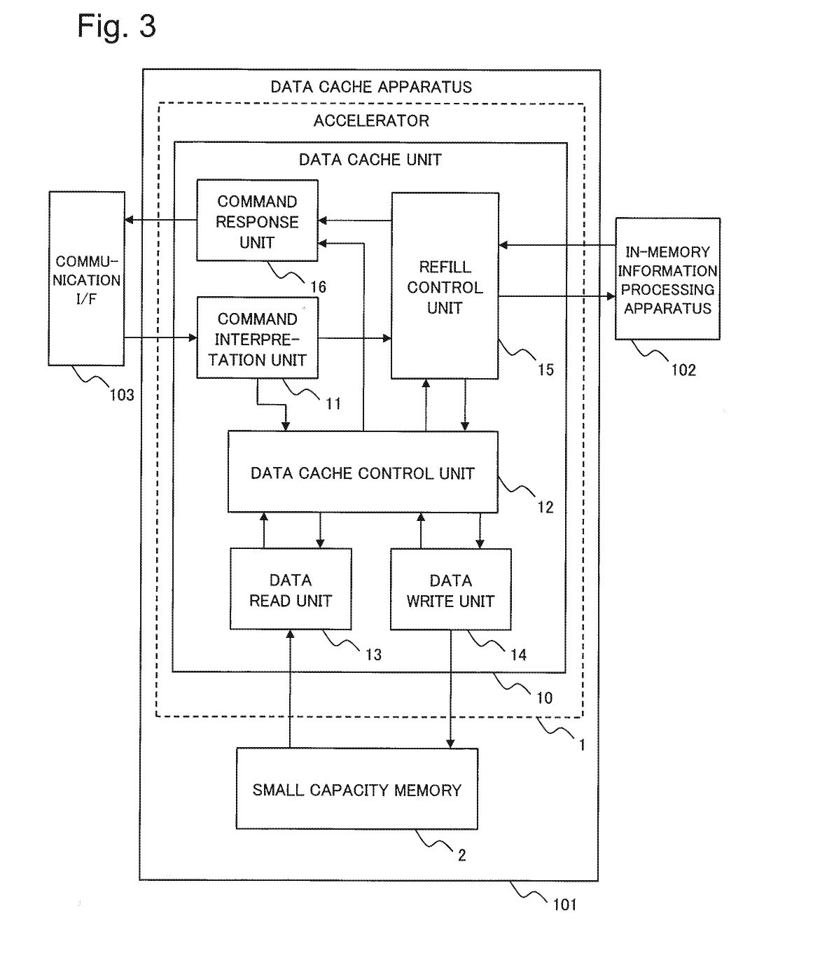

Next, referring to FIG. 3, the accelerator 1 of the data cache apparatus 101 will be described. FIG. 3 is a functional block diagram illustrating one example of a functional configuration of the accelerator 1 of the data cache apparatus 101.

The accelerator 1 includes a data cache unit 10 which processes a request from a network at a high speed. As shown in FIG. 3, the data cache unit 10 includes a command interpretation unit 11, a data cache control unit 12, a data read unit 13, a data write unit 14, a refill control unit 15, and a command response unit 16.

The command interpretation unit 11 is determination means for, by receiving a read/write request from the communication I/F 103 and interpreting the received request, determining whether the request is a request which is processed by the data cache apparatus 101 or not. The determination whether the request is a request which is processed by the data cache apparatus 101 or not is performed, for example, based on a character string included in an attribute name which is included in the read request #20 and the write request #10, a data length which is included in the write request #10, or the like. A standard for the determination is not limited thereto. When the command interpretation unit 11 determines that the received request is a request which is processed by the data cache apparatus 101, the command interpretation unit 11 provides the request to data cache control unit 12. On the other hand, when the command interpretation unit 11 determines that the received request is not a request which is processed by the data cache apparatus 101, the command interpretation unit 11 provides the request to the refill control unit 15.

The data cache apparatus 101 thus can control the received request to be processed by an appropriate apparatus. As a result, since data which is to be processed by the data cache apparatus 101 can be processed by the data cache apparatus 101 without providing the data to the in-memory information processing apparatus 102, a high speed data process can be achieve more preferably.

The data cache control unit 12 receives a request which the command interpretation unit 11 determines to be a request which is processed by the data cache apparatus 101 from the command interpretation unit 11. The data cache control unit 12 confirms whether data to be written included in the received write request #10 or data to be read by the received read request #20 is present in the small capacity memory 2 or not.

In the following, “data to be written included in the write request #10” and “data to be read by the read request #20” are also referred to as “data corresponding to the write request #10” and “data corresponding to the read request #20”, respectively. Data read by the read request #20 is also referred to as “read data”.

The data cache control unit 12 performs a read instruction or a write instruction to the data read unit 13 or the data write unit 14 in accordance with each request when data corresponding to each request is present in the small capacity memory 2.

When write data corresponding to the write request #10 is not present in the small capacity memory 2, the data cache control unit 12 confirms a free space of the small capacity memory 2 and compares the size of the free space with the data length of the write data.

The data cache control unit 12 then performs a write instruction to the data write unit 14 in accordance with the write request #10 when the data length is not larger than the size of the free space.

When data corresponding to the read request #20 is not present in the small capacity memory 2, the data cache control unit 12 transfers the read request #20 to the refill control unit 15. The data cache control unit 12 then receives read data corresponding to the read request #20 from the refill control unit 15 and compares the data length of the read data with the size of the free space of the small capacity memory 2.

When the data length is not larger than the size of the free space, the data cache control unit 12 performs a write instruction to the data write unit 14 to write the data (read data) read in accordance with the read request #20 to the small capacity memory 2.

When the following condition is fulfilled, the data cache control unit 12 confirms a last reference date and time of each data with respect to data stored in the small capacity memory 2, and selects data whose reference degree is lower.

Condition: The size of a free space of the small capacity memory 2 is smaller than the data length included in the write request #10 or the data length of read data corresponding to the read request #20.

The data cache control unit 12 then instructs the refill control unit 15 to locate the selected data in the large capacity memory 5, and instructs the data write unit 14 to locate data corresponding to the received request in the small capacity memory 2.

The data cache control unit 12 receives a response (read data read by the data read unit 13) to a read instruction from the data read unit 13, and provides the response to the command response unit 16. The data cache control unit 12 receives a response to a write instruction from the data write unit 14, and provides the response to the command response unit 16.

A detailed configuration of the data cache control unit 12 will be described with reference to another drawing.

The data read unit 13 reads data in a designated length from the small capacity memory 2 based on an instruction from the data cache control unit 12. The data read unit 13 provides the read data to the data cache control unit 12 as a response to the read instruction.

The data write unit 14 writes data in a designated length to the small capacity memory 2 based on the instruction from the data cache control unit 12. The data write unit 14 provides a response representing whether data writing is normally finished or not to the data cache control unit 12.

The refill control unit 15 transmits the write request #10 or the read request #20 provided from the command interpretation unit 11 or the data cache control unit 12 to the in-memory information processing apparatus 102.

The refill control unit 15 receives a response corresponding to the write request #10 or the read request #20 from the in-memory information processing apparatus 102. The refill control unit 15 provides the response to the command response unit 16 and/or the data cache control unit 12 depending on a request source of the request and a request type (the write request #10 or the read request #20) of a request corresponding to the received response.

The command response unit 16 generates the write response #15 or the read response #25 based on the response provided by the refill control unit 15 or the data cache control unit 12, and transmits it to the communication I/F 103.

In the present exemplary embodiment, description will be made by taking a method in which data whose reference degree is lower is located in the large capacity memory 5 as an example, but the present invention is not limited thereto. Depending on an instruction of the data cache control unit 12, data to be located in the small capacity memory 2 may be located in a first in first out (FIFO) order, a random order, or the like.

In the present exemplary embodiment, description will be made by taking a method in which data is written in the small capacity memory 2 when data to be written included in the write request #10 is not present in the small capacity memory 2 when the data cache apparatus 101 receives the write request #10 as an example, but the present invention is not limited thereto. In this case, the data cache apparatus 101 may be configured to transmit the write request #10 to the in-memory information processing apparatus 102.

In the present exemplary embodiment, the data cache unit 10 of the data cache apparatus 101 can employ parameters similar to design parameters in a cache configuration of a microprocessor.

(Detailed Configuration of Data Cache Control Unit 12)

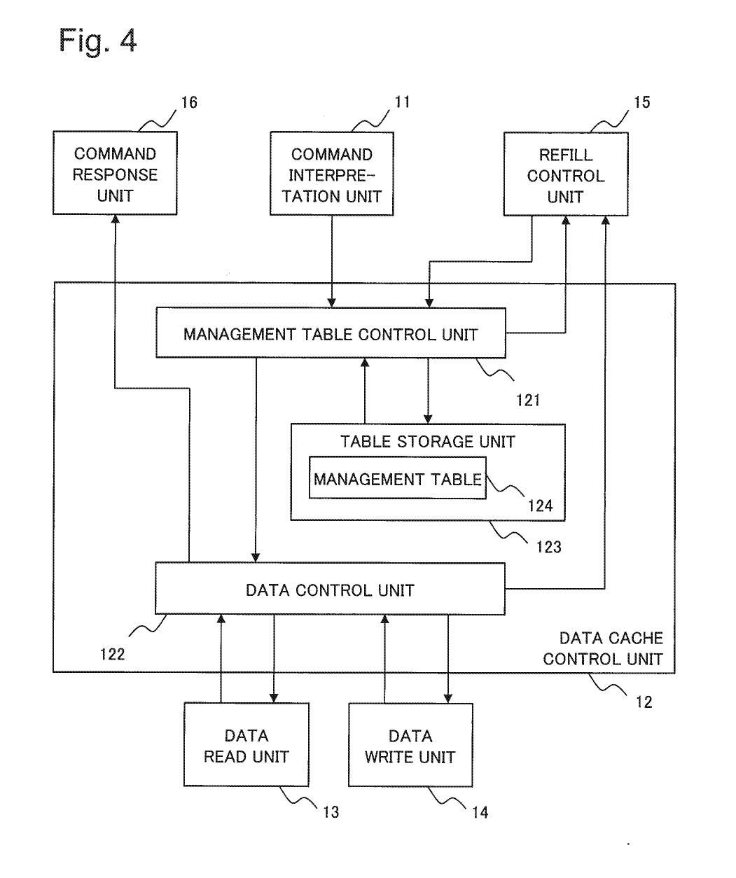

Next, referring to FIG. 4, a detailed configuration of the data cache control unit 12 will be described. FIG. 4 is a functional block diagram illustrating a detailed functional configuration of the data cache control unit 12. As illustrated in FIG. 4, the data cache control unit 12 includes a management table control unit 121, a data control unit 122, and a table storage unit 123.

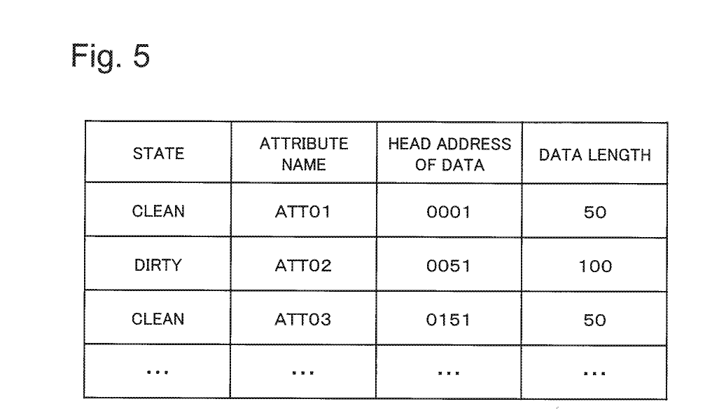

The table storage unit 123 is means for storing a management table 124. The management table 124 manages information about data stored in the small capacity memory 2. Referring to FIG. 5, the management table 124 will be described. FIG. 5 is a diagram illustrating one example of the management table 124 stored in the table storage unit 123. As illustrated in FIG. 5, the management table 124 stores a state of data, an attribute name, a head address of data, and a data length, which are associated with each other. Each row of the management table 124 is also referred to as “entry”. As mentioned above, the management table 124 according to the present exemplary embodiment includes a plurality of entries, each including a state, an attribute name, a head address of data, and a data length. Each row of the management table 124 is not limited thereto, and may be any information as long as the information represents data which the data cache apparatus 101 handles.

The attribute name specifies data, and corresponds to an attribute name included in the write request #10, the read request #20, and the read response #25.

The head address of data represents the head address in the small capacity memory 2 of data recorded in the small capacity memory 2. The data length represents the length of the data. The state represents the state of data such as “invalid”, “clean”, “dirty”, and “refill clean” in a similar manner to a cache of a microprocessor.

In the following, each state of data will be described. The term “invalid” represents that an entry having such a state is invalid.

“Clean” is a state in which an entry having such a state is valid, data is present in the small capacity memory 2, and the data corresponds to data stored in the large capacity memory 5 of the in-memory information processing apparatus 102. Here, a state in which data stored in the small capacity memory 2 corresponds to data stored in the large capacity memory 5 represents that, after data stored in the large capacity memory 5 is cached in the small capacity memory 2, data has not been written (updated) without passing data to the in-memory information processing apparatus 102.

“Dirty” is a state in which an entry having such a state is valid, data is present in the small capacity memory 2, and the data does not correspond to data stored in the large capacity memory 5 of the in-memory information processing apparatus 102. Here, a state in which data stored in the small capacity memory 2 does not correspond to data stored in the large capacity memory 5 represents that, after data stored in the large capacity memory 5 is cached in the small capacity memory 2, data has been written (updated) without passing data to the in-memory information processing apparatus 102.

“Refill clean” is a state in which an entry having such a state is valid, data is not present in the small capacity memory 2, and a read request of the data is performed to the in-memory information processing apparatus 102.

The state of data is not limited to the above-described four states. For example, the state may be a variety of states which can constitute a cache (see NPL 2).

As mentioned above, different from a cache of a microprocessor, the data cache control unit 12 of the data cache apparatus 101 according to the present exemplary embodiment utilizes information such as an attribute name, a head address of data, or a data length. Although the number of ways (candidate locations for storing data) of a cache is described as full-associative (capable of storing in any location) in the present exemplary embodiment, the number of ways can be varied from one to any number, in a similar manner to a cache of a microprocessor.

Since state information representing a state of the data is associated with the information of data, it is easy to confirm information such as whether data is valid or not or whether data stored in the small capacity memory 2 corresponds to data stored in the large capacity memory 5 or not.

Each value in each entry of FIG. 5 is one example, and not limited thereto.

Returning to FIG. 4, each function of the data cache control unit 12 will be described. The management table control unit 121 is means for managing the management table 124. The management table control unit 121 updates an entry of the management table 124 or adds an entry to the management table 124.

The management table control unit 121 receives a request from the command interpretation unit 11. The management table control unit 121 refers to the management table 124, and confirms whether data corresponding to the received write request #10 or data corresponding to the received read request #20 is present in the small capacity memory 2 or not. The confirmation whether data corresponding to each request is present in the small capacity memory 2 or not is performed by confirming whether, among entries included in the management table 124, an attribute name of an entry in which the state is “clean” or “dirty” corresponds to an attribute name included in each request or not. As mentioned above, since the management table control unit 121 refers to the management table 124, it is easy to confirm whether data corresponding to a read/write request is present in the small capacity memory 2 or not.

The management table control unit 121 refers to the management table 124, and manages a free space of the small capacity memory 2. In the present exemplary embodiment, the management table control unit 121 will be descried by taking management of a free space of the small capacity memory 2 based on a head address of data and a data length of the data included in an entry included in the management table 124 as an example, but the present invention is not limited thereto. For example, the present invention may be configured such that the management table control unit 121 or the data control unit 122 accesses the small capacity memory 2 to confirm a free space.

The management table control unit 121 issues an instruction to the data control unit 122 or the refill control unit 15 depending on (1) a request type (the write request #10 or the read request #20), (2) whether data corresponding to a request is present in the small capacity memory 2 or not, and (3) whether there is a free space whose size is not smaller than the data length of data corresponding to each request or not.

The management table control unit 121 confirms a last reference date and time of each data with respect to data stored in the small capacity memory 2 to select data whose reference degree is low. The entry of data whose reference degree is low is, for example, at least either (a) an entry whose state is invalid, or (b) an entry of data whose last reference date and time is the oldest, but not limited thereto. The management table control unit 121 provides a head address and a data length of data of the selected entry to the data control unit 122.

The order of entries the reference degree of which the management table control unit 121 of the data cache control unit 12 determines to be low is the order (a), (b) as described above, but not limited thereto. The management table control unit 121 of the data cache control unit 12 stores information of the selected entry. Hereinafter, the selected entry is referred to as “entry to be substituted”, and data corresponding to the entry is referred to as “data to be substituted”.

In order to specify data to be substituted, additional information to each data may be managed by preparing a least recently used (LRU) table, a FIFO order table, or the like. Since information of a reference date and time of data which is referred to in order to specify data to be substituted is information which a general cache has, a description thereof is omitted.

When a head address and a data length of data from the management table control unit 121 are provided to the data control unit 122, the data control unit 122 generates a read instruction to read data in the data length from the head address of data. The data control unit 122 transmits the generated read instruction to the data read unit 13.

When a head address of data, a data length, and data are provided from the management table control unit 121 to the data control unit 122, the data control unit 122 generates a write instruction to write the data in the data length from the head address of data. The data control unit 122 transmits a generated write instruction to the data write unit 14.

The data control unit 122 receives a response from the data read unit 13 and the data write unit 14. The data control unit 122 provides the received response to the command response unit 16.

When the data control unit 122 receives a response to the read request #20 of data to be substituted, the data control unit 122 generates the write request #10 for writing read data to the large capacity memory 5. The data control unit 122 transmits the generated write request #10 to the refill control unit 15.

(Processing Flow of Data Cache Apparatus 101)

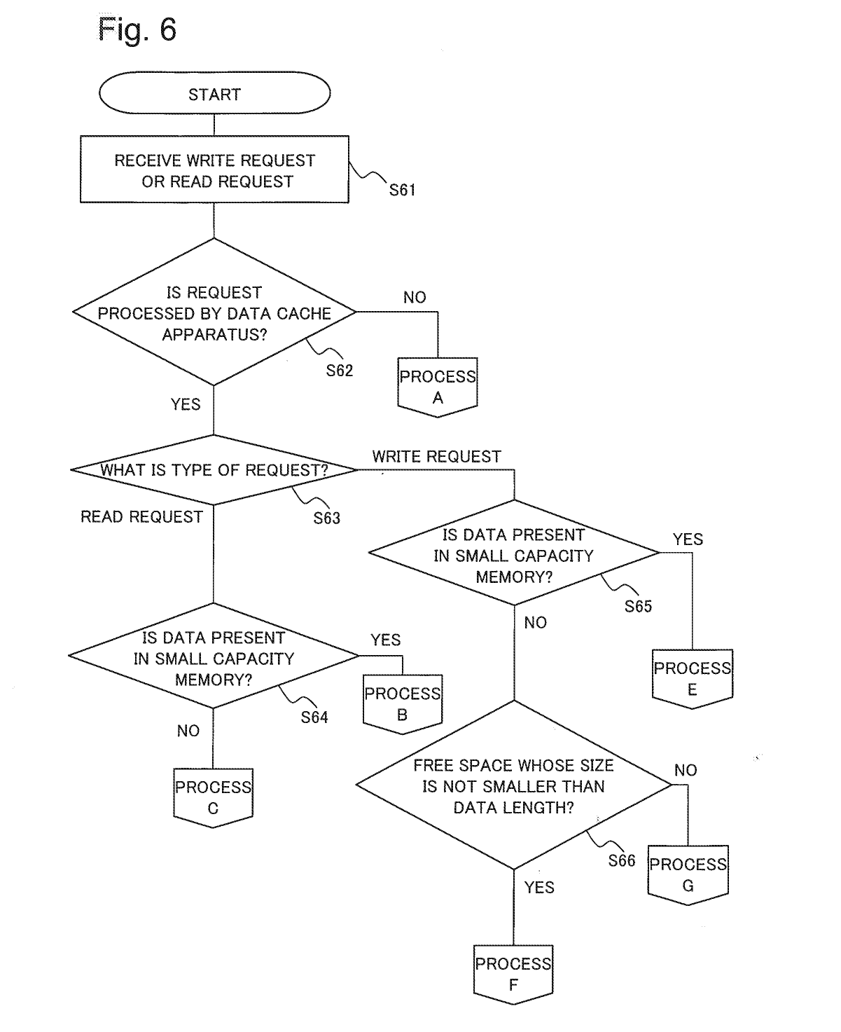

Next, referring to FIGS. 6 to 13, a processing flow of the data cache apparatus 101 of the information processing apparatus 100 according to the present exemplary embodiment will be described.

FIG. 6 is a flow chart illustrating one example of a processing flow of the data cache apparatus 101 according to the present exemplary embodiment.

As illustrated in FIG. 6, the data cache apparatus 101 performs processes of the following steps S61 to S66.

Step S61: The command interpretation unit 11 receives the write request #10 or the read request #20 from the communication I/F 103.

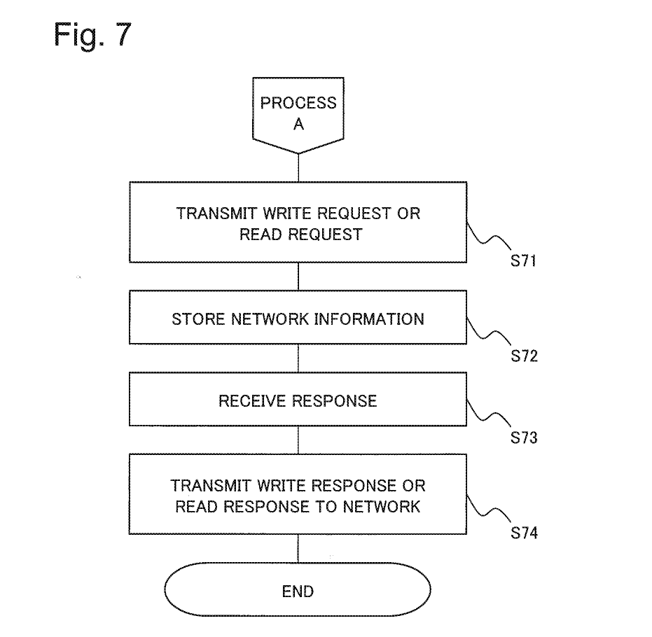

Step S62: The command interpretation unit 11 determines whether the write request #10 or the read request #20 received in step S61 is a request which is handled in the data cache apparatus 101 or not. When the write request #10 or read request #20 is a request which is handled in the data cache apparatus 101 (in the case of YES), the process proceeds to step S63. When the write request #10 or the read request #20 is not a request which is handled in the data cache apparatus 101 (in the case of NO), the process proceeds to process A (see FIG. 7).

Step S63: The data cache control unit 12 determines whether the request provided from the command interpretation unit 11 is the write request #10 or the read request #20. When the provided request is the read request #20, the process proceeds to step S64. When the request provided from the command interpretation unit 11 is the write request #10, the process proceeds to step S65.

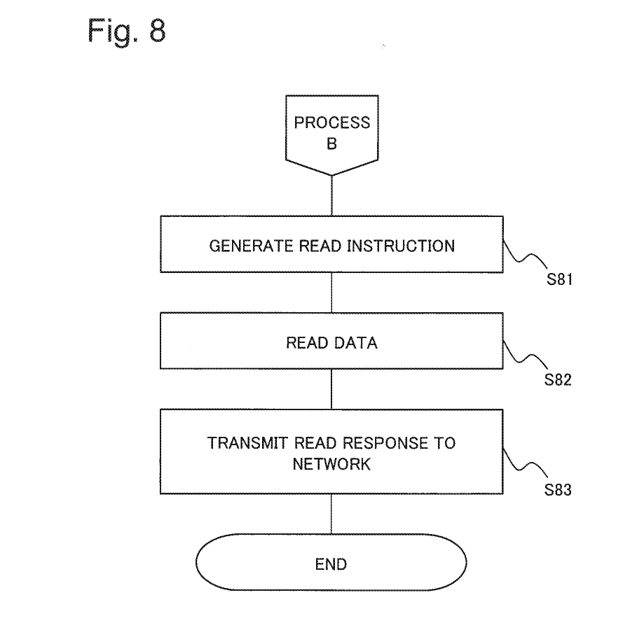

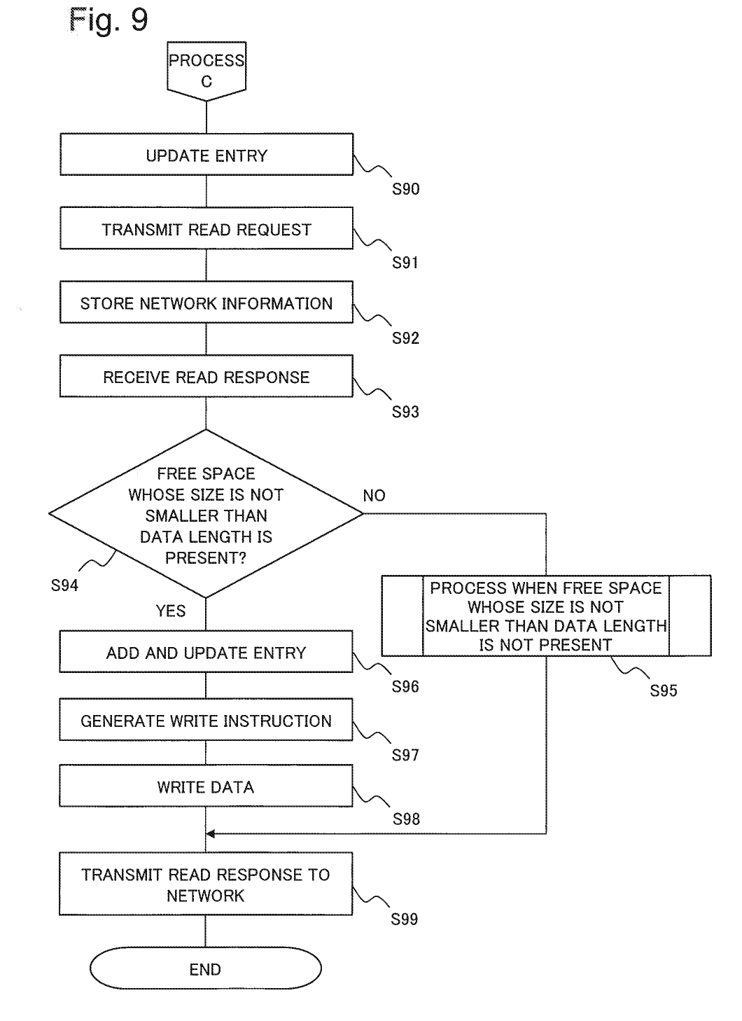

Step S64: The data cache control unit 12 confirms whether data corresponding to the read request #20 provided from the command interpretation unit 11 is present in the small capacity memory 2 or not. Specifically, the management table control unit 121 of the data cache control unit 12 confirms whether an attribute name included in the read request #20 is included in the management table 124 or not. When data corresponding to the read request #20 is present in the small capacity memory 2 (in the case of YES), the process proceeds to process B (see FIG. 8). When data corresponding to the read request #20 is not present in the small capacity memory 2 (in the case of NO), the process proceeds to process C (see FIG. 9).

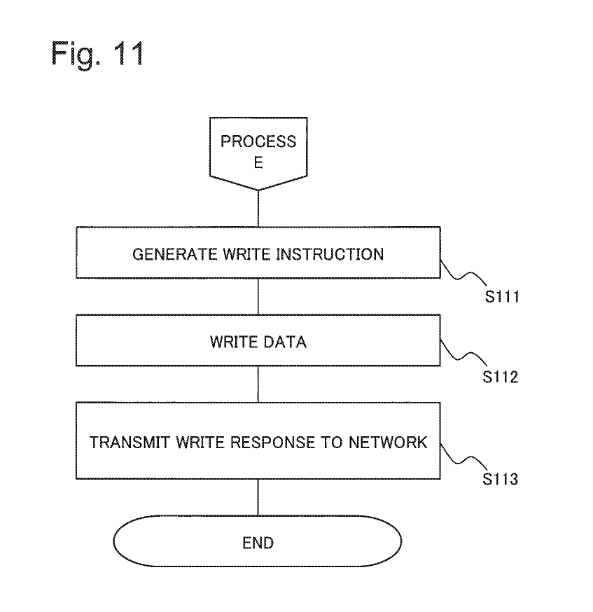

Step S65: The data cache control unit 12 confirms whether data corresponding to the write request #10 provided from the command interpretation unit 11 is present in the small capacity memory 2 or not. Specifically, the management table control unit 121 of the data cache control unit 12 confirms whether an attribute name included in the write request #10 is included in the management table 124 or not. When data corresponding to the write request #10 is present in the small capacity memory 2 (in the case of YES), the process proceeds to process E (see FIG. 11). When data corresponding to the write request #10 is not present in the small capacity memory 2 (in the case of NO), the process proceeds to step S66.

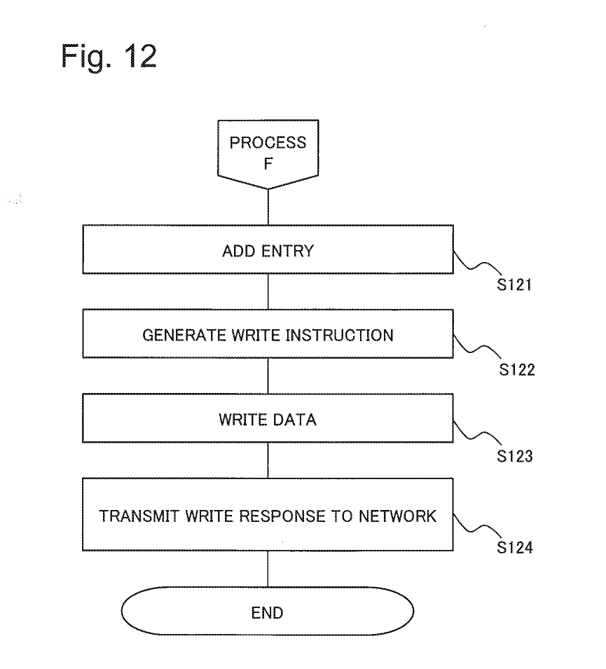

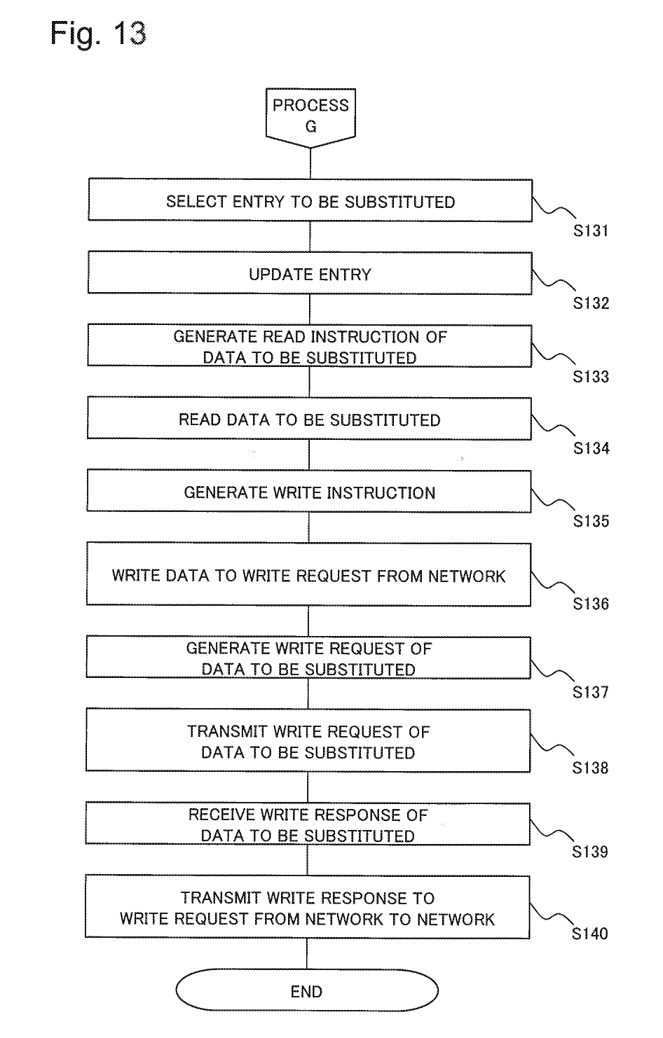

Step S66: The data cache control unit 12 determines whether the size of a free space of the small capacity memory 2 is not smaller than a data length included in the write request #10 or not. When the size of the free space is not smaller than the data length (in the case of YES), the process proceeds to process F (see FIG. 12). When the size of the free space is smaller than the data length (in the case of NO), the process proceeds to process G (see FIG. 13).

(Processing Flow of Data Cache Apparatus 101 in Cases in which Write Request #10 or Read Request #20 is not Request Handled in Data Cache Apparatus 101)

Referring to FIG. 7, a processing flow of the data cache apparatus 101 in cases in which the write request #10 or the read request #20 is not a request handled in the data cache apparatus 101 will be described. FIG. 7 is a flow chart illustrating one example of a processing flow of the data cache apparatus 101 in cases in which the write request #10 or the read request #20 is not a request handled in the data cache apparatus 101. In the case of NO in step S62 of FIG. 6, the command interpretation unit 11 provides the write request #10 or the read request #20 to the refill control unit 15. Then, as illustrated in FIG. 7, the data cache apparatus 101 performs processes of the following steps S71 to S74.

Step S71: The refill control unit 15 transmits the write request #10 or the read request #20 provided from the command interpretation unit 11 to the in-memory information processing apparatus 102.

Step S72: The refill control unit 15 stores network information of a request source. Step S72 may be performed simultaneously with step S71, or may be performed before step S71.

Step S73: The refill control unit 15 receives a response to a request transmitted in step S71 from the in-memory information processing apparatus 102.

Step S74: Since a request source of the request is another apparatus connected to a network and the request is provided from the command interpretation unit 11, the refill control unit 15 provides network information stored in step S72 and a response received in step S73 to the command response unit 16. The command response unit 16 generates the write response #15 or the read response #25 including the network information based on network information and a response received from the refill control unit 15, and transmits it to the network.

Accordingly, the information processing apparatus 100 according to the present exemplary embodiment can process a request which is not processed in the data cache apparatus 101 in the in-memory information processing apparatus 102.

(Processing Flow of Data Cache Apparatus 101 when Read Request #20 is Request which is Handled in Data Cache Apparatus 101 and Data Corresponding to Read Request #20 is Present in Small Capacity Memory 2)

Referring to FIG. 8, a processing flow of the data cache apparatus 101 when the read request #20 is a request which is handled in the data cache apparatus 101 and data corresponding to the read request #20 is present in the small capacity memory 2 will be described. FIG. 8 is a flow chart illustrating one example of a processing flow of the data cache apparatus 101 when the read request #20 is a request which is handled in the data cache apparatus 101 and data corresponding to the read request #20 is present in the small capacity memory 2. As illustrated in FIG. 8, the data cache apparatus 101 performs processes of the following steps S81 to S83.

Step S81: The data cache control unit 12 generates a read instruction to the data read unit 13 in accordance with the read request #20. Specifically, the data cache control unit 12 performs processes of the following (1) to (3).

(1) The management table control unit 121 of the data cache control unit 12 reads a head address of data and a data length of the data in an entry which has confirmed to include an attribute name included in the read request #20 in the step S64.

(2) The management table control unit 121 of the data cache control unit 12 provides the head address of data and the data length read from the management table 124 to the data control unit 122.

(3) The data control unit 122 generates a read instruction to read, from the small capacity memory 2, data in the data length from the head address, and transmits it to the data read unit 13.

Step S82: The data read unit 13 reads data from the small capacity memory 2 in accordance with the read instruction generated in step S81.

Step S83: The command response unit 16 receives data which the data read unit 13 has read in step S82 as a response to the read instruction from the data control unit 122 of the data cache control unit 12. The command response unit 16 then generates the read response #25 including an attribute name included in the read request #20 based on the received response, and transmits it to a network with network information of a request source.

Accordingly, when the read request #20 is determined to be processed in the data cache apparatus 101 and data corresponding to the read request #20 is present in the small capacity memory 2, the information processing apparatus 100 processes the read request #20 in the data cache apparatus 101.

(Processing Flow of Data Cache Apparatus 101 when Read Request #20 is Request which is Handled in Data Cache Apparatus 101 and Data Corresponding to Read Request #20 is not Present in Small Capacity Memory 2)

Referring to FIG. 9, a processing flow of the data cache apparatus 101 when the read request #20 is a request which is handled in the data cache apparatus 101 and data corresponding to read request #20 is not present in the small capacity memory 2 will be described. FIG. 9 is a flow chart illustrating one example of a processing flow of the data cache apparatus 101 when the read request #20 is a request which is handled in the data cache apparatus 101 and data corresponding to read request #20 is not present in the small capacity memory 2. As illustrated in FIG. 9, the data cache apparatus 101 performs processes of the following steps S90 to S99.

Step S90: The management table control unit 121 of the data cache control unit 12 extracts an entry of data whose reference degree is low from entries included in the management table 124. In the present example, description will be made by taking an example that the entry of data whose reference degree is low is extracted in the order, (a) an entry in which the state is “invalid”, (b) an entry of data whose last reference date and time is the oldest. In the case of (b), the management table control unit 121 may extract, when there are a plurality of entries of data whose last reference date and time is the oldest, the entry in which a data length included therein is the largest. Alternatively, the management table control unit 121 may extract an entry of data whose data length is the largest from entries of data whose last reference date and time is before a predetermined time period. The management table control unit 121 of the data cache control unit 12 updates the state of the extracted entry to “refill clean”. Hereinafter, the extracted entry is referred to as a “substitution candidate entry”. The management table control unit 121 stores information (an attribute name, a head address of data, and a data length) of a substitution candidate entry and a state in which the state has not updated to “refill clean”.

Step S91: The refill control unit 15 transmits the read request #20 provided from the data cache control unit 12 to the in-memory information processing apparatus 102.

Step S92: The refill control unit 15 stores network information of a request source. Step S92 may be performed simultaneously with step S91, or may be performed before step S91.

Step S93: The refill control unit 15 receives a response (read data which the in-memory information processing apparatus 102 has read) to the read request #20 transmitted in step S91 from the in-memory information processing apparatus 102. Since a request source of the request is another apparatus connected to a network and the request is provided from the data cache control unit 12, the refill control unit 15 then provides network information stored in step S92 and the received response to the command response unit 16 and the data cache control unit 12.

Step S94: The management table control unit 121 of the data cache control unit 12 confirms whether a free space of a size not smaller than the data length of data (read data corresponding to the read request #20) which the in-memory information processing apparatus 102 has read is present in the small capacity memory 2 or not based on a response provided by the refill control unit 15 in step S93. When a free space of a size not smaller than the data length of data corresponding to the read request #20 is present in the small capacity memory 2 (in the case of YES), the process proceeds to step S96. When a free space of a size not smaller than the data length of data corresponding to the read request #20 is not present in the small capacity memory 2 (in the case of NO), the process proceeds to step S95.

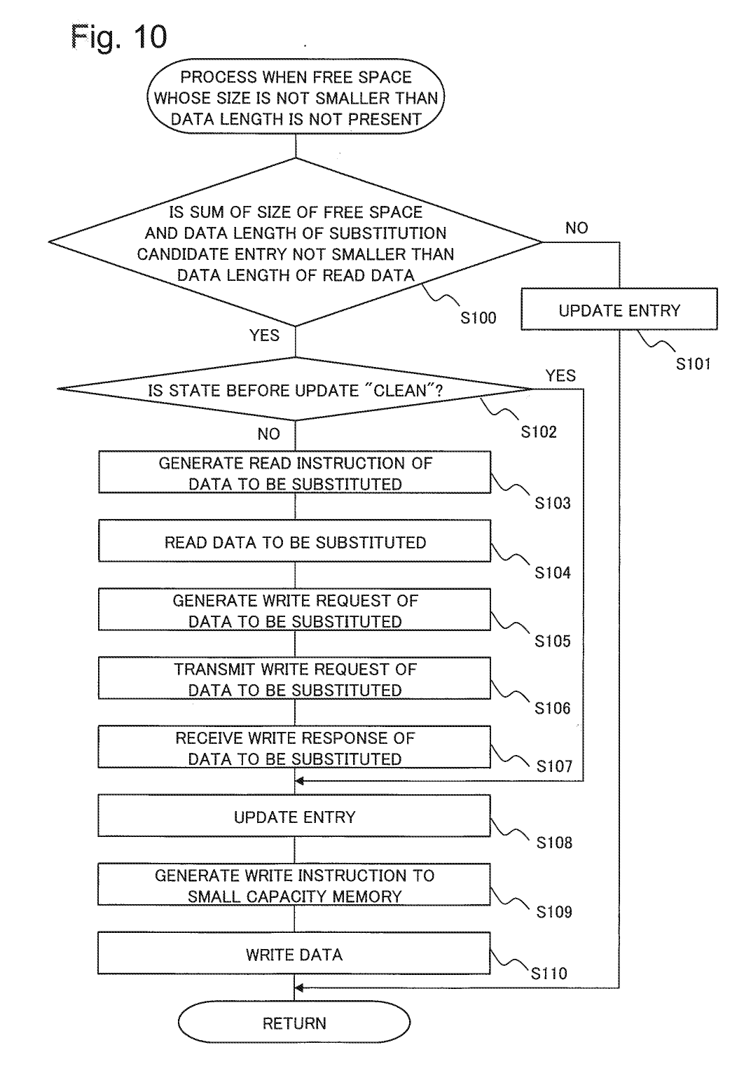

Step S95: The data cache control unit 12 performs a process when a free space of a size not smaller than the data length of read data is not present in the small capacity memory 2. This process will be described with reference to FIG. 10.

Step S96: When a free space of a size not smaller than the data length of read data is present in the small capacity memory 2 (in the case of YES in step S94), the management table control unit 121 of the data cache control unit 12 adds a new entry to the management table 124. The management table control unit 121 sets “state”, “attribute name”, “head address of data” and “data length” of added entry to “clean”, attribute name included in read request #20, address of a free space, and, data length of the read data, respectively. The management table control unit 121 also updates the state of a substitution candidate entry extracted in step S90 to the original state.

Step S97: The data cache control unit 12 generates a write instruction to write read data to the data write unit 14. Specifically, the data cache control unit 12 performs processes of the following (1) and (2).

(1) The management table control unit 121 of the data cache control unit 12 provides a head address of data and a data length included in the entry added in step S96, and read data to the data control unit 122.

(2) The data control unit 122 generates a write instruction to write the data in the data length from the head address to the small capacity memory 2, and transmits it to the data write unit 14.

Step S98: The data write unit 14 writes data to the small capacity memory 2 in accordance with the write instruction generated in step S97.

Step S99: The command response unit 16 generates the read response #25 including the network information based on network information and a response received from the refill control unit 15, and transmits it to a network.

Accordingly, when the following (A) to (C) are fulfilled, the information processing apparatus 100 according to the present exemplary embodiment processes the read request #20 in the data cache apparatus 101, and further locates the read data in the small capacity memory 2.

(A) The read request #20 is determined to be processed in the data cache apparatus 101.

(B) Data corresponding to the read request #20 is not present in the small capacity memory 2.

(C) A free space of a size not smaller than the data length of data corresponding to the read request #20 is present in the small capacity memory 2.

(Processing Flow of Data Cache Apparatus 101 in Step S95)

Referring to FIG. 10, the above-mentioned processing flow of step S95 will be described. Specifically, a processing flow of the data cache apparatus 101 when the following (A) to (C) are fulfilled will be described. FIG. 10 is a flow chart illustrating one example of a processing flow of the data cache apparatus 101 when the following (A) to (C) are fulfilled, and represents a detailed process of step S95 of FIG. 9.

(A) The read request #20 is a request which the data cache apparatus 101 handles.

(B) Data corresponding to the read request #20 is not present in the small capacity memory 2.

(C) The size of a free space of the small capacity memory 2 is smaller than the data length of the read data read by the read request #20.

As illustrated in FIG. 10, the data cache apparatus 101 performs the following steps S100 to S110.

Step S100: The data cache control unit 12 determines whether the sum of the data length of a substitution candidate entry and the size of a free space of the small capacity memory 2 is not smaller than the data length of a response (read data which the in-memory information processing apparatus 102 has read) to the read request #20. When the sum is not smaller than the data length (in the case of YES), the process proceeds to step S102. When the sum is smaller than the data length (in the case of NO), the process proceeds to step S101.

Step S101: The management table control unit 121 of the data cache control unit 12 updates the state of the substitution candidate entry extracted in step S90 to “invalid”, and terminates the process. The management table control unit 121 may update the state of the substitution candidate entry to the original state.

Step S102: The management table control unit 121 of the data cache control unit 12 confirms whether the state of the substitution candidate entry stored in step S90 which has not been updated is “clean” or not. When the state before the update is “clean” (in the case of YES), the process proceeds to step S108. When the state before the update is not “clean” (in the case of NO), the process proceeds to step S103.

Step S103: The data cache control unit 12 sets the substitution candidate entry to an entry to be substituted, and generates a read instruction of data to be substituted to the data read unit 13. Specifically, the data cache control unit 12 performs the following processes (1) and (2).

(1) The management table control unit 121 of the data cache control unit 12 provides a head address of data of an entry to be substituted (substitution candidate entry) and a data length of the data stored in step S90 to the data control unit 122.

(2) The data control unit 122 generates a read instruction to read data in the data length from the head address from the small capacity memory 2, and transmits it to the data read unit 13.

Step S104: The data read unit 13 reads data (data to be substituted) from the small capacity memory 2 in accordance with the read instruction generated in step S103.

Step S105: The data control unit 122 of the data cache control unit 12 receives data to be substituted which the data read unit 13 has read in step S104 from the data read unit 13. The data control unit 122 then generates the write request #10 of the data to be substituted.

Step S106: The refill control unit 15 transmits the write request #10 of data to be substituted which the data control unit 122 of the data cache control unit 12 has generated in step S105 to the in-memory information processing apparatus 102.

Step S107: The refill control unit 15 receives a response to the write request #10 which has been transmitted in step S106 from the in-memory information processing apparatus 102. Since a request source of the request is the data cache control unit 12, the refill control unit 15 provides the received response to the data cache control unit 12.

Step S108: The management table control unit 121 of the data cache control unit 12 sets a “state” and a “data length” of an entry to be substituted to “clean” and a data length of data corresponding to the read request #20, respectively. In cases in which the head address of data varies depending on the position of a free space of the small capacity memory 2 and the locate position of data to be substituted in the small capacity memory 2 when data corresponding to the read request #20 is written, the management table control unit 121 updates a “head address of data” of the entry to be substituted.

Step S109: The data cache control unit 12 generates a write instruction of read data corresponding to the read request #20 to the data write unit 14. Specifically, the data cache control unit 12 performs the following processes (1) and (2).

(1) The management table control unit 121 of the data cache control unit 12 provides a head address of data included in the entry updated in step S108 and read read data and a data length of the data to the data control unit 122.

(2) The data control unit 122 generates a write instruction to write the data in the data length from the head address to the small capacity memory 2, and transmits it to the data write unit 14.

Step S110: The data write unit 14 writes data to the small capacity memory 2 in accordance with the write instruction generated in step S109. The process then proceeds to step S99 of FIG. 9.

When a response to the write request #10 of data to be substituted received in S107 is a response that the writing is not normally finished, the data cache control unit 12 skips the steps S108 to S110. Further, the management table control unit 121 of the data cache control unit 12 sets the state of an entry to be substituted to “invalid”, or sets it back to the original state.

After step S110, in step S99 of FIG. 9, as mentioned above, the command response unit 16 generates the read response #25 including the network information based on network information and a response received from the refill control unit 15, and transmits it to a network.

Accordingly, when the following (A) to (C) are fulfilled, the information processing apparatus 100 according to the present exemplary embodiment reads data corresponding to the read request #20 from the in-memory information processing apparatus 102, and selects data to be substituted such that the read read data is located in the small capacity memory 2.

(A) The read request #20 is determined to be processed in the data cache apparatus 101.

(B) Data corresponding to the read request #20 is not present in the small capacity memory 2.

(C) A free space of a size not smaller than the data length of data corresponding to the read request #20 is not present in the small capacity memory 2.

When the sum of the data length of data to be substituted and the size of a free space of the small capacity memory 2 is not smaller than the data length of read data, the data cache control unit 12 locates the read data in the small capacity memory 2, and locates data to be substituted in the large capacity memory 5.

As a result, since the information processing apparatus 100 can locate data (for example, read data) whose reference degree is high in the high speed small capacity memory 2 and locate data whose reference degree is low in the large capacity memory 5, a data process can be performed at a higher speed.

(Processing Flow of Data Cache Apparatus 101 when Write Request #10 is Request which is Handled in Data Cache Apparatus 101 and Data Corresponding to Write Request #10 is Present in Small Capacity Memory 2)

Referring to FIG. 11, a processing flow of the data cache apparatus 101 when the write request #10 is a request which is handled in the data cache apparatus 101 and data corresponding to the write request #10 is present in the small capacity memory 2 will be described. FIG. 11 is a flow chart illustrating one example of a processing flow of the data cache apparatus 101 when the write request #10 is a request which is handled in the data cache apparatus 101 and data corresponding to the write request #10 is present in the small capacity memory 2. As illustrated in FIG. 11, the data cache apparatus 101 performs processes of the following steps S111 to S113.

Step S111: The data cache control unit 12 generates a write instruction to the data write unit 14 in accordance with the write request #10.

Specifically, the data cache control unit 12 performs processes of the following (1) to (3).

(1) The management table control unit 121 of the data cache control unit 12 reads a head address of data in an entry which has confirmed to include an attribute name included in the write request #10 in the step S65.

(2) The management table control unit 121 of the data cache control unit 12 provides a head address of the read data read from the management table 124, and a data length and data included in the write request #10 to the data control unit 122.

(3) The data control unit 122 generates a write instruction to write the data in the data length from the head address to the small capacity memory 2, and transmits it to the data write unit 14.

Step S112: The data write unit 14 writes data to the small capacity memory 2 in accordance with the write instruction generated in step S111.

Step S113: The command response unit 16 receives response information representing whether the writing of the data write unit 14 based on the write request #10 is normally finished or not as a response to data writing of the data write unit 14 in step S112 from the data control unit 122 of the data cache control unit 12. The command response unit 16 then generates the write response #15 including the response information based on the received response, and transmits it to a network with network information of a request source.

Accordingly, when the write request #10 is determined to be processed in the data cache apparatus 101 and write data corresponding to the write request #10 is present in the small capacity memory 2, the information processing apparatus 100 processes the write request #10 in the data cache apparatus 101.

(Processing Flow (1) of Data Cache Apparatus 101 when Write Request #10 is Request which is Handled in Data Cache Apparatus 101 and Data Corresponding to Write Request #10 is not Present in Small Capacity Memory 2)

Referring to FIG. 12, a processing flow of the data cache apparatus 101 when the following (A) to (C) are fulfilled will be described. FIG. 12 is a flow chart illustrating one example of a processing flow of the data cache apparatus 101 when the following (A) to (C) are fulfilled.

(A) The write request #10 is a request which is handled in the data cache apparatus 101.

(B) Data corresponding to the write request #10 is not present in the small capacity memory 2.

(C) The size of a free space of the small capacity memory 2 is not smaller than a data length included in the write request #10.

As illustrated in FIG. 12, the data cache apparatus 101 performs processes of the following steps S121 to S124.

Step S121: The management table control unit 121 of the data cache control unit 12 adds a new entry to the management table 124. The management table control unit 121 sets a “state”, an “attribute name”, a “head address of data”, and a “data length” of the added entry to “dirty”, an attribute name included in the write request #10, an address of a free space, and a data length included in the write request #10, respectively.

Step S122: The data cache control unit 12 generates a write instruction to the data write unit 14 in accordance with the write request #10. Specifically, the data cache control unit 12 performs processes of the following (1) and (2).

(1) The management table control unit 121 of the data cache control unit 12 provides a head address of data included in an entry added in step S121 and a data length and data included in the write request #10 to the data control unit 122.

(2) The data control unit 122 generates a write instruction to write the data in the data length from the head address to the small capacity memory 2, and transmits it to the data write unit 14.

Step S123: The data write unit 14 writes data to the small capacity memory 2 in accordance with the write instruction generated in step S122.

Step S124: The command response unit 16 receives response information representing whether the writing of data with respect to the write request #10 is normally finished or not as a response to data writing of the data write unit 14 (step S123) from the data control unit 122 of the data cache control unit 12. The command response unit 16 then generates the write response #15 including the response information based on the received response, and transmits it to a network with network information of a request source.

When response information representing that the write request #10 is not normally finished is received in step S124, the management table control unit 121 of the data cache control unit 12 deletes the entry added in step S121.

Accordingly, when the following (A) to (C) are fulfilled, the information processing apparatus 100 according to the present exemplary embodiment processes the write request #10 in the data cache apparatus 101.

(A) The write request #10 is determined to be processed in the data cache apparatus 101.

(B) Data corresponding to the write request #10 is not present in the small capacity memory 2.

(C) A free space of a size not smaller than the data length of data corresponding to the write request #10 is present in the small capacity memory 2.

(Processing Flow (2) of Data Cache Apparatus 101 When Write Request #10 is Request Which is Handled in Data Cache Apparatus 101 and Data Corresponding to Write Request #10 is Not Present in Small Capacity Memory 2)

Referring to FIG. 13, a processing flow of the data cache apparatus 101 when the following (A) to (C) are fulfilled will be described. FIG. 13 is a flow chart illustrating one example of a processing flow of the data cache apparatus 101 when the following (A) to (C) are fulfilled.

(A) The write request #10 is a request which is handled in the data cache apparatus 101.

(B) Data corresponding to the write request #10 is not present in the small capacity memory 2.

(C) The size of a free space of the small capacity memory 2 is smaller than a data length included in the write request #10.

As illustrated in FIG. 13, the data cache apparatus 101 performs processes of the following steps S131 to S140.

Step S131: The data cache control unit 12 selects an entry of data whose reference degree is low as an entry to be substituted from data in which the sum of a data length of an entry included in the management table 124 and the size of a free space of the small capacity memory 2 is not smaller than a data length included in the write request #10. In the present example, description will be made by taking an example that the entry of data whose reference degree is low is extracted in the order, (a) an entry in which the state is “invalid”, (b) an entry of data whose last reference date and time is the oldest. The management table control unit 121 of the data cache control unit 12 stores information of the selected entry to be substituted.

Step S132: The management table control unit 121 of the data cache control unit 12 sets a “state” and a “data length” of the entry to be substituted selected in step S131 to “dirty” and a data length included in the write request #10, respectively. Cases in which the head address of data varies depending on the position of a free space of the small capacity memory 2 and the locate position of data to be substituted in the small capacity memory 2 when data included in the write request #10 is written will be described. In such a case, the management table control unit 121 updates a “head address of data” of the selected entry.

Step S133: The data cache control unit 12 generates a read instruction of data to be substituted to the data read unit 13. Specifically, the data cache control unit 12 performs processes of the following (1) and (2).

(1) The management table control unit 121 of the data cache control unit 12 provides a head address of data of the entry to be substituted stored in step S131 and a data length of the data to the data control unit 122.

(2) The data control unit 122 generates a read instruction to read data in the data length from the head address from the small capacity memory 2, and transmits it to the data read unit 13.

Step S134: The data read unit 13 reads data (data to be substituted) from the small capacity memory 2 in accordance with the read instruction generated in step S133.

Step S135: The data cache control unit 12 generates a write instruction to the data write unit 14 in accordance with the write request #10. Specifically, the data cache control unit 12 performs processes of the following (1) and (2).

(1) The management table control unit 121 of the data cache control unit 12 provides a head address of data included in an entry updated in step S132 and a data length and data included in the write request #10 to the data control unit 122.

(2) The data control unit 122 generates a write instruction to write the data in the data length from the head address to the small capacity memory 2, and transmits it to the data write unit 14.

Step S136: The data write unit 14 writes data to the small capacity memory 2 in accordance with the write instruction generated in step S135.

Step S137: The data control unit 122 of the data cache control unit 12 receives data to be substituted which the data read unit 13 has read in step S134. The data control unit 122 then generates the write request #10 of the data to be substituted.

Step S138: The refill control unit 15 transmits the write request #10 of data to be substituted which the data control unit 122 of the data cache control unit 12 generates in step S137 to the in-memory information processing apparatus 102.

Step S139: The refill control unit 15 receives a response to the write request #10 transmitted in step S138 from the in-memory information processing apparatus 102. Since a request source of the request is data cache control unit 12, the refill control unit 15 provides the received response to the data cache control unit 12.

Processes (step S135 to step S136) to the write request #10 received from a network and processes (step S137 to step S139) to the write request #10 of data to be substituted which the data cache control unit 12 has generated may be performed simultaneously, or either of these may be performed first.

Step S140: The command response unit 16 receives response information representing whether writing of data to the write request #10 is normally finished or not as a response to writing (step S136) of data by the data write unit 14 from the data control unit 122 of the data cache control unit 12. The command response unit 16 then generates the write response #15 including the response information based on the received response, and transmits it to a network with network information of a request source.

When writing of data to be substituted by the write request #10 is not normally finished, the data cache control unit 12 provides notification of an abnormal finish of the write request #10 of data to be substituted to the command response unit 16 in step S140. When notification of the abnormal finish is received, the command response unit 16 transmits the write response #15 including response information that writing of data has not normally finished as a response to the write request #10 transmitted from a network. The data cache control unit 12 sets data to be substituted and an entry to the data to be substituted back to the state before step S131 is performed.

Cases in which the management table control unit 121 of the data cache control unit 12 determines that data in which the sum of the size of a free space of the small capacity memory 2 and a data length of the data is not smaller than a data length included in the write request #10 is not present in step S131 will be described. In such a case, the data cache control unit 12 transfers a write instruction to the refill control unit 15, and the data cache apparatus 101 performs processes of steps S71 to S74. In such a case, a provider of the request is the data cache control unit 12, and a response to the request is provided to the command response unit 16 in a similar manner to step S74.

Accordingly, when the following (A) to (C) are fulfilled, the information processing apparatus 100 according to the present exemplary embodiment locates data to be substituted in the large capacity memory 5, and processes the write request #10 in the data cache apparatus 101. As a result, the information processing apparatus 100 locates data corresponding to the write request #10 in the small capacity memory 2.

(A) The write request #10 is determined to be processed in the data cache apparatus 101.

(B) Data corresponding to the write request #10 is not present in the small capacity memory 2.

(C) A free space of a size not smaller than the data length of data corresponding to the write request #10 is not present in the small capacity memory 2.

### Advantageous Effect

By the information processing apparatus 100 according to the present exemplary embodiment, it is possible to handle a large capacity of data at a higher speed.

This is because when the data cache control unit 12 of the data cache apparatus 101 receives a read request or a write request from outside, data whose reference degree is lower stored in the small capacity memory 2 is located in the large capacity memory 5 of the in-memory information processing apparatus 102, and the data cache control unit 12 then writes data to be written or data read in accordance with a read request to the small capacity memory 2.

As a result, the information processing apparatus 100 can locate data whose reference degree is higher such as read data or write data in the small capacity memory 2 which can be processed at a high speed. Therefore, even a large capacity of data can be handled at a higher speed.

### Second Embodiment

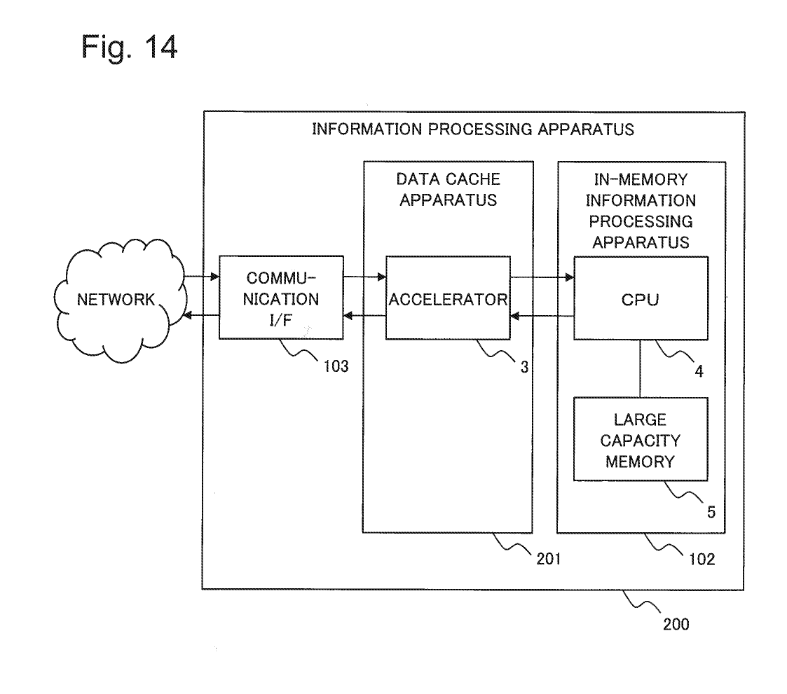

A second exemplary embodiment of the present invention will be described with reference to FIGS. 14 to 17. The first exemplary embodiment has been described taking a configuration that the small capacity memory 2 is separate from the accelerator 1 as an example. In the present exemplary embodiment, an example in which a cache memory equivalent to the small capacity memory 2 is included in an accelerator will be described. For convenience of description, to a member which has a function similar to that of the member included in the drawing described in the above-described first exemplary embodiment, the same reference sign is assigned, and the description thereof will be omitted.

(Information Processing Apparatus 200)

FIG. 14 is a block diagram illustrating a hardware configuration of an information processing apparatus 200 according to a second exemplary embodiment of the present invention. As shown in FIG. 14, the information processing apparatus 200 includes a data cache apparatus 201, an in-memory information processing apparatus 102 and a communication I/F 103. The data cache apparatus 201 includes an accelerator 3.

(Accelerator 3)

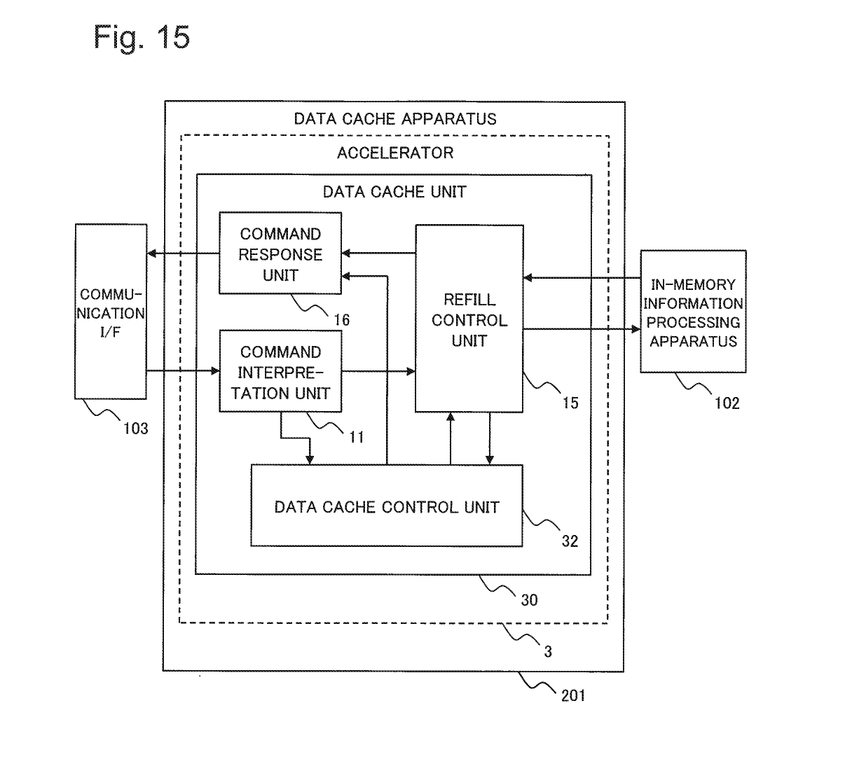

Next, referring to FIG. 15, the accelerator 3 of the data cache apparatus 201 will be described. FIG. 15 is a functional block diagram illustrating a functional configuration of the accelerator 3 of the data cache apparatus 201.

The accelerator 3 includes a data cache unit 30 which processes a request from a network at a high speed. As shown in FIG. 15, the data cache unit 30 includes a command interpretation unit 11, a data cache control unit 32, a refill control unit 15, and a command response unit 16.

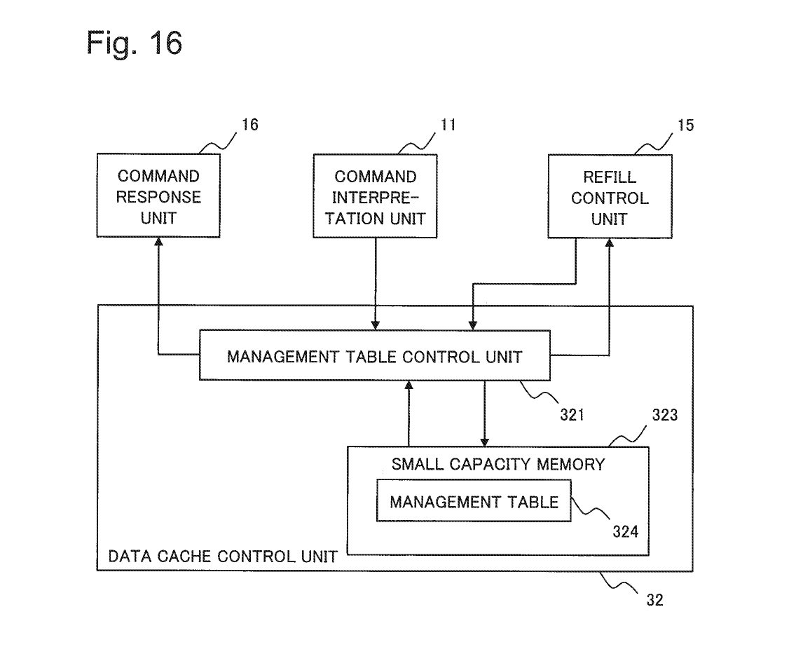

The data cache control unit 32 has a function similar to that of the data cache control unit 12 of the first exemplary embodiment. A detailed configuration of the data cache control unit 32 will be described with reference to FIG. 16.

(Detailed Configuration of Data Cache Control Unit 32)

Next, referring to FIG. 16, a detailed configuration of the data cache control unit 32 will be described. FIG. 16 is a functional block diagram illustrating a detailed functional configuration of the data cache control unit 32. As illustrated in FIG. 16, the data cache control unit 32 includes a management table control unit 321 and a small capacity memory 323.

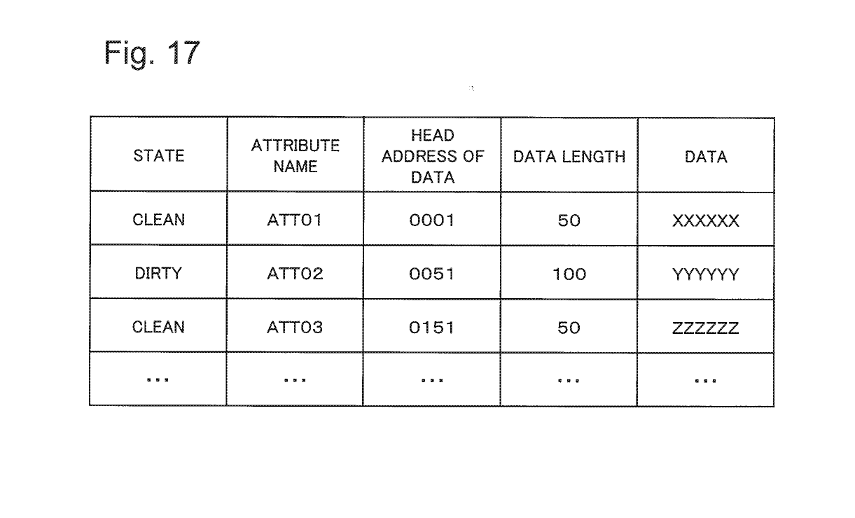

The small capacity memory 323 is equivalent to the table storage unit 123 and the small capacity memory 2 according to the first exemplary embodiment. The small capacity memory 323 stores a management table 324. Referring to FIG. 17, the management table 324 will be described. FIG. 17 is a diagram illustrating one example of the management table 324 stored in the small capacity memory 323. The management table 324 is different from the management table 124 of the first exemplary embodiment is that data corresponding to each entry is stored. As illustrated in FIG. 17, the management table 324 stores a state of data, an attribute name, a head address of data, a data length, and data, which are associated with each other.

Returning to FIG. 16, each function of the data cache control unit 32 will be described. The management table control unit 321 is means for managing the management table 324. The management table control unit 321 updates an entry of the management table 324 or adds an entry to the management table 324.

The management table control unit 321 confirms whether data corresponding to a request received from the command interpretation unit 11 is present in the small capacity memory 323 or not in a similar manner to the management table control unit 121 of the first exemplary embodiment.

The management table control unit 321 refers to the management table 324, and manages a free space of the small capacity memory 323. The management table control unit 321 issues an instruction to the refill control unit 15 depending on (1) a request type (the write request #10 or the read request #20), (2) whether data corresponding to a request is present in the small capacity memory 323 or not, and (3) whether there is a free space whose size is not smaller than the data length of data corresponding to each request or not.

The management table control unit 321 confirms a last reference date and time of each data with respect to data stored in the management table 324 of the small capacity memory 323 to select data whose reference degree is low. The entry of data whose reference degree is low is, for example, at least either (a) an entry whose state is invalid, or (b) an entry of data whose last reference date and time is the oldest, but not limited thereto.

The order of entries the reference degree of which the management table control unit 321 of the data cache control unit 32 determines to be low is the order (a), (b) as described above, but not limited thereto. The management table control unit 321 of the data cache control unit 32 stores information of the selected entry.

The management table control unit 321 reads/writes data from the management table 324 in accordance with a request. Such a response is provided to the command response unit 16.

When an entry to be substituted is selected, the management table control unit 321 reads data (data to be substituted) included in an entry to be substituted. The write request #10 for writing read data to be substituted to the large capacity memory 5 is then generated. The management table control unit 321 transmits the generated write request #10 to the refill control unit 15.

### Advantageous Effect

As mentioned above, the data cache apparatus 201 according to the present exemplary embodiment includes the accelerator 3 including the small capacity memory 323.

As a result, the data cache apparatus 201 does not need to include the data control unit 122, the data read unit 13, and the data write unit 14, unlike the first exemplary embodiment. Accordingly, by the data cache apparatus 201 of the present exemplary embodiment, data can be read/written without mediating a plurality of means; and therefore, data can be accessed at a high speed.

### Third Embodiment

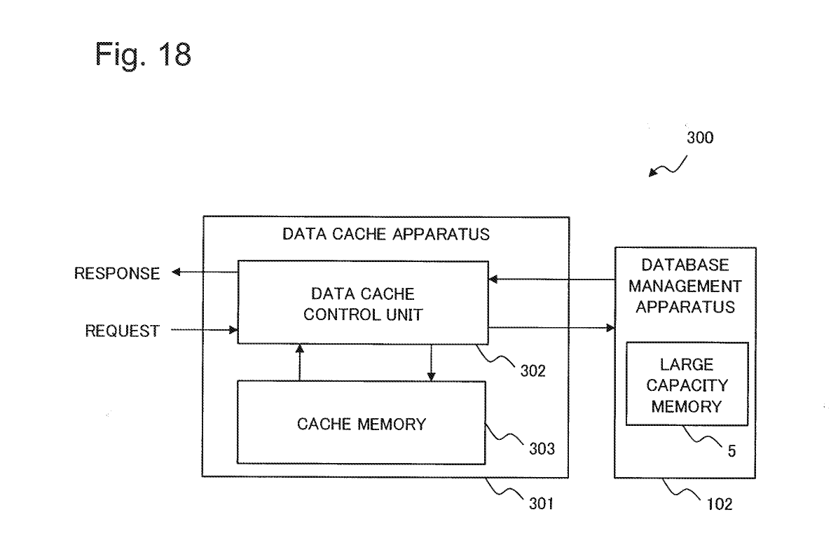

Next, a third exemplary embodiment will be described with reference to FIG. 18. For convenience of description, to a member which has a function similar to that of the member included in the drawing described in the above-described first exemplary embodiment, the same reference sign is assigned, and the description thereof will be omitted.

FIG. 18 is a block diagram illustrating one example of a configuration of an information processing apparatus 300 according to the present exemplary embodiment. As illustrated in FIG. 18, the information processing apparatus 300 includes the data cache apparatus 301 and the database management apparatus 102.

The database management apparatus (also simply referred to as a “management apparatus”) 102 includes the large capacity memory 5 whose capacity is larger than that of a cache memory 303. Since a configuration of the database management apparatus 102 is similar to that of the in-memory information processing apparatus 102 according to the first and the second exemplary embodiment, the description thereof will be omitted.

The data cache apparatus 301 includes the data cache control unit 302 and the cache memory 303. The data cache control unit 302 is implemented, for example, by an accelerator. The cache memory 303 may be configured to be prepared in the accelerator, or may be configured to be separated from the accelerator.

When the data cache apparatus 301 receives a read request or a write request from outside the information processing apparatus 300, the data cache control unit 302 controls data in a predetermined condition stored in the cache memory 303 to be located in the large capacity memory 5. Data in a predetermined condition is, for example, data whose reference degree is lower or data of a specific type, but not limited thereto in the present exemplary embodiment. Examples of data of the specific type include data in which a state in an entry is “invalid”.

When the received request is a write request, the data cache control unit 302 writes data to be written to the cache memory 303 in accordance with the write request. When the received request is a read request, the data cache control unit 302 writes data read in accordance with the read request to the cache memory 303.

Accordingly, the information processing apparatus 300 locates data in a predetermined condition in the large capacity memory 5 of the database management apparatus 102, and locates data to be read or data to be written in the cache memory 303.

As a result, data corresponding to a write request or data corresponding to a read request is stored in the cache memory 303 which can be processed at a high speed, and data in a predetermined condition is located in the large capacity memory 5. Therefore, even a large capacity of data can be handled at a higher speed.

### Fourth Embodiment

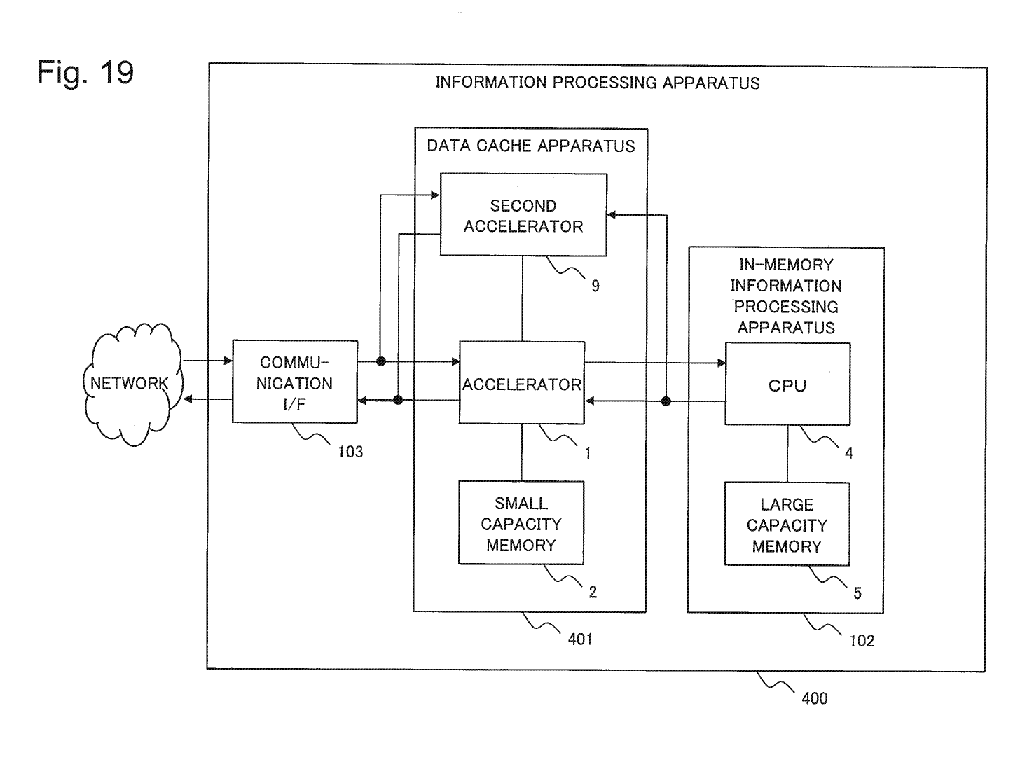

Next, a fourth exemplary embodiment of the present invention will be described with reference to FIGS. 19 to 21. For convenience of description, to a member which has a function similar to that of the member included in the drawing described in the above-described first to third exemplary embodiments, the same reference sign is assigned, and the description thereof will be omitted.

An information processing apparatus 400 according to the present exemplary embodiment is configured such that the data cache apparatus 101 of the information processing apparatus 100 according to the first exemplary embodiment includes a second accelerator 9. The information processing apparatus 400 according to the present exemplary embodiment is not limited thereto. The information processing apparatus 400 may be configured such that the data cache apparatus 201 of the information processing apparatus 200 according to the second exemplary embodiment includes the second accelerator 9, or such that the data cache apparatus 301 of the information processing apparatus 300 according to the third exemplary embodiment includes the second accelerator 9.

(Information Processing Apparatus 400)

FIG. 19 is a block diagram illustrating one example of a hardware configuration of the information processing apparatus 400 according to a fourth exemplary embodiment of the present invention. As shown in FIG. 19, the information processing apparatus 400 includes a data cache apparatus 401, the in-memory information processing apparatus 102, and the communication I/F 103. The data cache apparatus 401 includes the accelerator 1, the small capacity memory 2, and the second accelerator 9. Since the in-memory information processing apparatus 102 and the communication I/F 103 of the information processing apparatus 400 are similar to the in-memory information processing apparatus 102 and the communication I/F 103 according to each of the above-described exemplary embodiments, the description thereof will be omitted.

In a similar manner to the accelerator 1, the second accelerator 9 is implemented, for example, by an FPGA or a many-core processor. The second accelerator 9 is connected to the accelerator 1. The second accelerator 9 determines whether data having an attribute name of a read/write request is present in the in-memory information processing apparatus 102 or not. A functional configuration of the second accelerator 9 will be described with reference to another drawing.

The second accelerator 9 may be configured to be implemented on a device identical to the accelerator 1, or may be configured to be implemented on a device different from the accelerator 1.

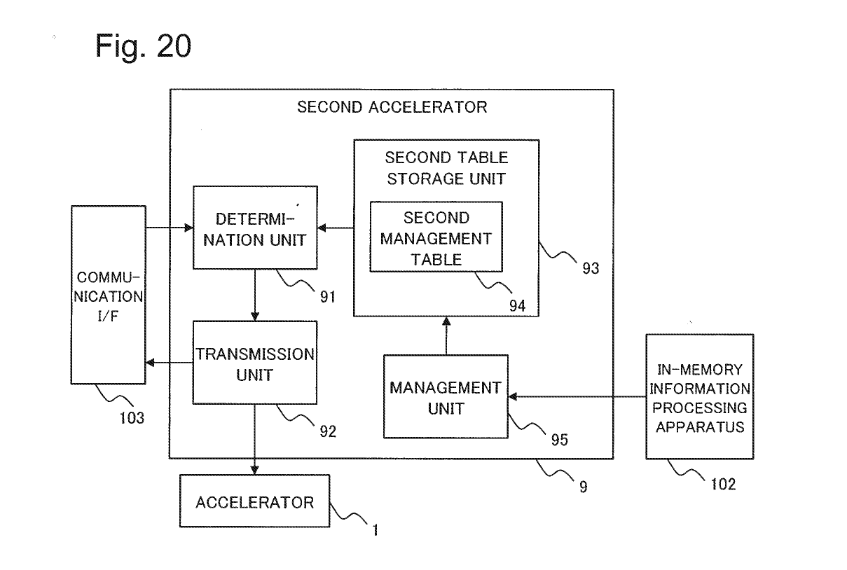

Next, referring to FIG. 20, the second accelerator 9 of the data cache apparatus 401 will be described. FIG. 20 is a functional block diagram illustrating one example of a functional configuration of the second accelerator 9 of the data cache apparatus 401.

As illustrated in FIG. 20, the second accelerator 9 includes a determination unit (data presence determination means) 91, a transmission unit 92, a second table storage unit 93, and a management unit 95.

The second table storage unit 93 is means for storing a second management table 94. The second management table 94 manages information representing whether data specified by an attribute name is stored in the large capacity memory 5 of the in-memory information processing apparatus 102 or not. The second management table 94 includes an attribute name and information associated with the attribute name. The latter information is information representing whether data specified by an attribute name is stored in the large capacity memory 5 or not. The second management table 94 may include an attribute name included in data stored in the large capacity memory 5. According to this, that an attribute name is included in the second management table 94 is information that data specified by the attribute name is stored in the large capacity memory 5.

The second management table 94 may further include information which is associated with an attribute name and which represents the in-memory information processing apparatus 102 storing data specified by the attribute name. For example, it is assumed that a plurality of information processing apparatuses 400 are connected with each other via a network and that a certain information processing apparatus 400 has received a request. It is also assumed that the in-memory information processing apparatus 102 including the large capacity memory 5 storing data specified by an attribute name included in the received request is the in-memory information processing apparatus 102 included in another information processing apparatus. In such a case, the second management table 94 includes information representing the in-memory information processing apparatus 102.

The above-described information may be not information representing the in-memory information processing apparatus 102 included in another information processing apparatus. The above-described information may be information representing the another information processing apparatus, or may be information representing the large capacity memory 5 included in the in-memory information processing apparatus 102 of the another information processing apparatus. In other words, the second management table 94 may store information representing where data specified by an attribute name is stored.

The second table storage unit 93 may be included in the second accelerator 9, or may be configured to be separated from the second accelerator 9.

The management unit 95 is means for managing the second management table 94 stored in the second table storage unit 93. The management unit 95 receives a response similar to a response (for example, a response received in step S73) which the refill control unit 15 receives from the in-memory information processing apparatus 102. The management unit 95 then updates information of the second management table 94 in accordance with the response.

When, in addition to information representing data stored in the in-memory information processing apparatus 102, information representing data stored in another in-memory information processing apparatus as described above is included in the second management table 94, the management unit 95 manages such information. In this case, the management unit 95 may be configured such that, when a response is transmitted to a data cache apparatus connected to another in-memory information processing apparatus from the another in-memory information processing apparatus, information about data stored in the another in-memory information processing apparatus is acquired via a network and updated.

The determination unit 91 receives a read/write request from the communication I/F 103. The determination unit 91 refers to the second table storage unit 93, and determines (presence determination) whether data specified by an attribute name included in the received request is stored in the in-memory information processing apparatus 102 or not. The presence determination of data specified by an attribute name which the determination unit 91 performs may be attained by a variety of algorithms, for example, may be implemented by a Counting Bloom Filter or the like. When the data is not stored in the in-memory information processing apparatus 102, the determination unit 91 provides information representing a transmission destination of a received request to the transmission unit 92.

When the data is not stored in the in-memory information processing apparatus 102, the transmission unit 92 receives information representing a transmission destination of a request which the determination unit 91 has received from the determination unit 91. The transmission unit 92 then terminates each process in the data cache apparatus 401 to a request which the determination unit 91 has received. Specifically, the transmission unit 92 transmits a terminate instruction for terminating a process which the accelerator 1 executes and which corresponds to a request which the accelerator 1 has received to the accelerator 1. When the accelerator 1 receives this instruction, the accelerator 1 can terminate a process in execution.

The transmission unit 92 transmits a response to another apparatus via a network. Specifically, the transmission unit 92 transmits, to a transmission destination of a request, a response representing that target data for the request is not present in own apparatus which has received the request via the communication I/F 103.

When the second management table 94 includes information representing the in-memory information processing apparatus 102 of another information processing apparatus which stores data specified by an attribute name included in the received request, the determination unit 91 may provide information representing the in-memory information processing apparatus 102 of the another information processing apparatus to the transmission unit 92 with the received request. In such a case, the transmission unit 92 may transfer the request to the another information processing apparatus via the communication I/F 103.

(Processing Flow of Second Accelerator 9)

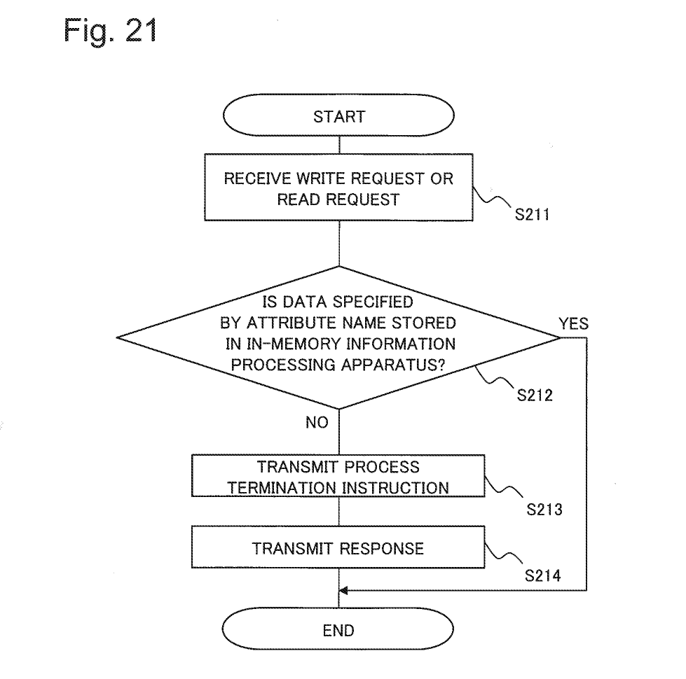

Next, referring to FIG. 21, a processing flow of the second accelerator 9 in the data cache apparatus 401 according to the present exemplary embodiment will be described. FIG. 21 is a diagram illustrating one example of the processing flow of the second accelerator 9 in the data cache apparatus 401 according to the present exemplary embodiment.

As illustrated in FIG. 21, the second accelerator 9 performs processes of the following steps S211 to S214.

Step S211: The determination unit 91 receives the write request #10 or the read request #20 from the communication I/F 103. The request which is received at this time is similar to a request which the command interpretation unit 11 of the accelerator 1 receives in the above-described step S61.

Step S212: The determination unit 91 determines whether data specified by an attribute name included in the received request is stored in the in-memory information processing apparatus 102 or not. When the data is stored (in the case of YES), the second accelerator 9 terminates the process. The data cache apparatus 401 thus performs processes (processes illustrated in FIGS. 6 to 13) similar to those in cases of data cache apparatuses according to the first to third exemplary embodiments in which the second accelerator 9 is not present. When the data is not stored (in the case of NO), the process proceeds to step S213.

Step S213: The transmission unit 92 transmits a process termination instruction to the accelerator 1 in order to terminate each process in the data cache apparatus 401 to a request which the determination unit 91 has received. As a result, the accelerator 1 terminates processes (for example, processes represented by FIGS. 6 to 13) in execution.

Step S214: The transmission unit 92 transmits, to a transmission destination of a request, a response representing that target data for the request is not present in own apparatus which has received the request, or transmits, to another information processing apparatus which stores data specified by an attribute name included in a request which the determination unit 91 has received, the request. The second accelerator 9 then terminates the process.

Step S213 and step S214 may be performed in a reversed order, or they may be performed simultaneously.

### Advantageous Effect

By the information processing apparatus 400 according to the present exemplary embodiment, a large capacity of data can be handled at a higher speed.

This is: because when a read request or a write request is received from outside the information processing apparatus 400, the second accelerator 9 of the data cache apparatus 401 determines whether data corresponding to the received request is stored in the in-memory information processing apparatus 102 or not; because when the data is not stored, the second accelerator 9 transmits a response to another apparatus; and because the transmission unit 92 of the second accelerator 9 of the data cache apparatus 401 terminates a process (a process of the accelerator 1) in the data cache apparatus 401 to a request.

As a result, when data corresponding to the received request is not stored (not present) in the in-memory information processing apparatus 102 of the information processing apparatus 400, the second accelerator 9 can transmit a response before the accelerator 1 transmits a response to a request source of the request. Therefore, by the information processing apparatus 400 according to the present exemplary embodiment, the average response delay of a whole system including the information processing apparatus 400 can be reduced.

When data corresponding to the received request is not stored in the in-memory information processing apparatus 102 of the information processing apparatus 400, the information processing apparatus 400 according to the present exemplary embodiment transfers the received request to another information processing apparatus including the in-memory information processing apparatus 102 storing the data.

As a result, a process time for a request source of a request to find the in-memory information processing apparatus 102 storing data corresponding to the request can be reduced. The average response delay of a whole system including the information processing apparatus 400 can thus be reduced.

Each of the above-described exemplary embodiments is a preferable exemplary embodiment of the present invention, and the scope of the present invention is not limited thereto. Those skilled in the art can construct an embodiment to which a variety of changes are applied by modifications or substitutions in each of the above-described exemplary embodiments without deviating from the spirit of the present invention.

For example, each operation in the above-described exemplary embodiments can be executed by a configuration of either or both of a hardware and/or software.

When a process by a software is executed, the process can be executed, for example, by installing a program on a general purpose computer which can execute each of the above-described processes. The above-described program can be recorded on a recording medium such as a hard disk.

A part or whole of the above-described exemplary embodiments can also be described in the following Supplementary notes, but not limited thereto.

(Supplementary Note 1)

An information processing apparatus including: a data cache apparatus including a cache memory; and a management apparatus including a large capacity memory whose capacity is larger than that of the cache memory, wherein the data cache apparatus includes data cache control means for controlling data in a predetermined condition stored in the cache memory to be located in the large capacity memory when a read request or a write request is received from outside the information processing apparatus, and wherein when the received request is a write request, the data cache control means writes data to be written to the cache memory in accordance with the write request, and when the request is a read request, the data cache control means writes data read in accordance with the read request to the cache memory.

(Supplementary Note 2)

The information processing apparatus according to Supplementary note 1, wherein the data cache control means confirms whether data corresponding to the received request is present in the cache memory or not, when data corresponding to the request is present in the cache memory, reads data or writes data from/to the cache memory in accordance with the request, and when data corresponding to the request is not present in the cache memory, controls the data in a predetermined condition to be located in the large capacity memory and writes the data to be written or data read in accordance with the read request to the cache memory.

(Supplementary Note 3)

The information processing apparatus according to Supplementary note 2, wherein the data cache control means, when data corresponding to the request is not present in the cache memory, further confirms whether there is a free space whose size is not smaller than the data length of the data to be written or data to be read in the read request or not, when there is a free space whose size is not smaller than the data length in the cache memory, writes data read from the large capacity memory to the free space of the cache memory in accordance with the data to be written or the read request, and when there is not a free space whose size is not smaller than the data length of the cache memory in the cache memory, controls the data in a predetermined condition to be located in the large capacity memory, and further, writes the data to be written or data read in accordance with the read request to the cache memory.

(Supplementary Note 4)

The information processing apparatus according to Supplementary note 2 or 3, wherein the data cache control means includes management table control means for controlling a management table for managing information about data stored in the cache memory, wherein the management table includes, as information about the data, an identifier representing data, a data length of the data, a head address of the data in the cache memory, and wherein the management table control means confirms whether data corresponding to the received request is present in the cache memory or not by referring to the management table.

(Supplementary note 5) The information processing apparatus according to Supplementary note 4, wherein the management table control means manages state information representing a state of the data by associating with information about the data.

(Supplementary note 6) The information processing apparatus according to Supplementary note 5, wherein the management table control means updates the state information when the data cache control means controls the data in a predetermined condition to be located in the large capacity memory and writes the data to be written or data read in accordance with the read request to the cache memory.

(Supplementary Note 7)

The information processing apparatus according to Supplementary note 5 or 6, wherein the data in a predetermined condition is data in which the state information is information representing that the data is in an invalid state.

(Supplementary Note 8)

The information processing apparatus according to any one of Supplementary notes 1 to 7, wherein the data in a predetermined condition is data in which a reference degree is lower.

(Supplementary Note 9)

The information processing apparatus according to Supplementary note 8, wherein the data in which a reference degree is lower is data whose last reference date and time is the oldest.

(Supplementary Note 10)

The information processing apparatus according to any one of Supplementary notes 4 to 7, wherein the cache memory is included in the data cache control means, wherein the cache memory stores the management table, and wherein the management table includes a data body of the data as information about the data.

(Supplementary Note 11)

The information processing apparatus according to any one of Supplementary notes 1 to 10, wherein the data cache apparatus includes: data presence determination means for determining, when a read request or a write request is received from outside the information processing apparatus, whether data corresponding to the received request is stored in the management apparatus or not; and transmission means for transmitting a response to another apparatus when the data is not stored in the management apparatus, wherein the transmission means terminates a process in the data cache apparatus for the request.

(Supplementary Note 12)

The information processing apparatus according to Supplementary note 11, wherein the transmission means transmits a response representing that data corresponding to the request is not stored in the management apparatus to a transmission destination of the request.

(Supplementary Note 13)

The information processing apparatus according to Supplementary note 11, wherein the data cache apparatus further includes management means for managing information representing data stored in the management apparatus connected to the data cache apparatus and another management apparatus included in each of one or a plurality of other information processing apparatuses connected to the data cache apparatus via a network, wherein, when data corresponding to the request is stored in the another management apparatus, the transmission means transmits the received request to another information processing apparatus including the the another management apparatus.

(Supplementary Note 14)

The information processing apparatus according to any one of Supplementary notes 1 to 13, wherein the data cache apparatus further includes: determination means for receiving a read request or a write request from outside the information processing apparatus, and determining whether the received read request or the received write request is a request which is processed by the data cache apparatus or not; and refill control means for transmitting the read request or the write request to the management apparatus, and receiving a read response or a write response corresponding to the read request or the write request, respectively, wherein the determination means provides the read request or the write request to the refill control means when the received read request or the received write request is determined not to be a request which is processed in the data cache apparatus, and provides the read request or the write request to the data cache control means when the received read request or the received write request is determined to be a request which is processed in the data cache apparatus.

(Supplementary Note 15)

A data cache apparatus which includes a cache memory, and which is connected to a management apparatus including a large capacity memory whose capacity is larger than that of the cache memory, the data cache apparatus including data cache control means for controlling data in a predetermined condition stored in the cache memory to be located in the large capacity memory when a read request or a write request is received from outside the data cache apparatus and the management apparatus, wherein when the received request is a write request, the data cache control means writes data to be written to the cache memory in accordance with the write request, and when the request is a read request, the data cache control means writes data read in accordance with the read request to the cache memory.

(Supplementary Note 16)

The data cache apparatus according to Supplementary note 15, wherein the data cache control means confirms whether data corresponding to the received request is present in the cache memory or not, when data corresponding to the request is present in the cache memory, reads data or writes data with respect to the cache memory in accordance with the request, and when data corresponding to the request is not present in the cache memory, controls the data in a predetermined condition to be located in the large capacity memory and writes the data to be written or data read in accordance with the read request to the cache memory.

(Supplementary Note 17)

The data cache apparatus according to Supplementary note 16, wherein the data cache control means further confirms whether a free space of a size not smaller than the data length of the data to be written or data to be read in the read request is present in the cache memory or not when data corresponding to the request is not present in the cache memory, when a free space of a size not smaller than the data length of the cache memory is present in the cache memory, writes data read from the large capacity memory in accordance with the data to be written or the read request to the free space of the cache memory, and when a free space of a size not smaller than the data length of the cache memory is not present in the cache memory, controls the data in a predetermined condition to be located in the large capacity memory and further writes data read in accordance with the data to be written or the read request to the cache memory.

(Supplementary Note 18)

The data cache apparatus according to Supplementary note 16 or 17, wherein the data cache control means includes management table control means for controlling a management table for managing information about data stored in the cache memory, wherein the management table includes, as information about the data, an identifier representing data, a data length of the data, and a head address of the data in the cache memory, and wherein the management table control means confirms whether data corresponding to the received request by referring to the management table.

(Supplementary Note 19)

The data cache apparatus according to Supplementary note 18, wherein the management table control means manages state information representing a state of the data by associating with information about the data.

(Supplementary Note 20)

The data cache apparatus according to Supplementary note 19, wherein the management table control means updates the state information when the data cache control means controls the data in a predetermined condition to be located in the large capacity memory and writes the data to be written or data read in accordance with the read request to the cache memory.

(Supplementary Note 21)

The data cache apparatus according to Supplementary note 19 or 20, wherein the data in a predetermined condition is data in which the state information is information representing that the data is in an invalid state.

(Supplementary Note 22)

The data cache apparatus according to any one of Supplementary notes 15 to 21, wherein the data in a predetermined condition is data in which a reference degree is lower.

(Supplementary Note 23)

The data cache apparatus according to Supplementary note 22, wherein the data in which a reference degree is lower is data whose last reference date and time is the oldest.

(Supplementary Note 24)

The data cache apparatus according to any one of Supplementary notes 18 to 21, wherein the cache memory is included in the data cache control means, wherein the cache memory stores the management table, and wherein the management table includes a data body of the data as information about the data.

(Supplementary Note 25)

The data cache apparatus according to any one of Supplementary notes 15 to 24, including: data presence determination means which, when a read request or a write request is received from outside the data cache apparatus and the management apparatus, determines whether data corresponding to the received request is stored in the management apparatus or not; and transmission means which, when the data is not stored in the management apparatus, transmits a response to another apparatus, wherein the transmission means terminates a process in the data cache apparatus for the request.

(Supplementary Note 26)

The data cache apparatus according to Supplementary note 25, wherein the transmission means transmits a response representing that data corresponding to the request is not stored in the management apparatus to a transmission destination of the request.

(Supplementary Note 27)

The data cache apparatus according to Supplementary note 25, further including: management means for managing information representing data stored in the management apparatus connected to the data cache apparatus and another management apparatus connected to each of one or a plurality of other data cache apparatuses connected to the data cache apparatus via a network, wherein when data corresponding to the request is stored in the another management apparatus, the transmission means transmits the received request to another data cache apparatus connected to the another management apparatus.

(Supplementary Note 28)

The data cache apparatus according to any one of Supplementary notes 15 to 27, further including: determination means which receives a read request or a write request from outside the data cache apparatus and the management apparatus, and determines whether the received read request or the received write request is a request which is processed by own apparatus or not; and refill control means which transmits the read request or the write request to the management apparatus, and receives a read response or a write response corresponding to the read request or the write request, respectively, wherein the determination means provides the read request or the write request to the refill control means when the received read request or the received write request is determined not to be a request which is processed by own apparatus, and provides the read request or the write request to the data cache control means when the received read request or the received write request is determined to be a request which is processed by own apparatus.

(Supplementary Note 29)

An information processing method of an information processing apparatus including a data cache apparatus including a cache memory and a management apparatus including a large capacity memory whose capacity is larger than that of the cache memory, the method including: receiving a read request or a write request from outside the information processing apparatus; when the received request is a write request, controlling data in a predetermined condition stored in the cache memory to be located in the large capacity memory and further writing data to be written to the cache memory in accordance with the write request; and when the received request is a read request, controlling the data in the predetermined condition to be located in the large capacity memory and further writing data read in accordance with the read request to the cache memory.

(Supplementary Note 30)

A data caching method of a data cache apparatus which includes a cache memory and which is connected to a management apparatus including a large capacity memory whose capacity is larger than that of the cache memory, the method including: receiving a read request or a write request from outside the data cache apparatus and the management apparatus; when the received request is a write request, controlling data in a predetermined condition stored in the cache memory to be located in the large capacity memory and further writing data to be written to the cache memory in accordance with the write request; and when the received request is a read request, controlling the data in the predetermined condition to be located in the large capacity memory and further writing data read in accordance with the read request to the cache memory.

(Supplementary Note 31)

A program to allow a computer including an information processing apparatus including a data cache apparatus including a cache memory and a management apparatus including a large capacity memory whose capacity is larger than that of the cache memory to execute: a process which receives a read request or a write request from outside the information processing apparatus; a process which, when the received request is a write request, controls data in a predetermined condition stored in the cache memory to be located in the large capacity memory and further writes data to be written to the cache memory in accordance with the write request; and a process which, when the received request is a read request, controls the data in the predetermined condition to be located in the large capacity memory and further writes data read in accordance with the read request to the cache memory.

(Supplementary Note 32)

A program to allow a computer including a data cache apparatus which includes a cache memory and which is connected to a management apparatus including a large capacity memory whose capacity is larger than that of the cache memory to execute: a process which receives a read request or a write request from outside the data cache apparatus and the management apparatus; a process which, when the received request is a write request, controls data in a predetermined condition stored in the cache memory to be located in the large capacity memory and further writes data to be written to the cache memory in accordance with the write request; and a process which, when the received request is a read request, controls the data in a predetermined condition to be located in the large capacity memory and further writes data read in accordance with the read request to the cache memory.

(Supplementary Note 33)

A computer readable recording medium on which the program according to Supplementary note 31 or 32 is recorded.

The present invention has been described taking the above-described exemplary embodiments as exemplary examples. The present invention, however, is not limited to the above-described exemplary embodiments. In other words, a variety of aspects which can be understood by those skilled in the art can be applied to the present invention within the scope of the present invention.

This application claims a priority based on Japanese Patent Application No. 2013-228291 filed on Nov. 1, 2013 and Japanese Patent

Application No. 2014-082152 filed on Apr. 11, 2014, the disclosures of which are hereby incorporated in their entirety.

### REFERENCE SIGNS LIST

1 Accelerator
2 Small capacity memory
3 Accelerator
4 CPU
5 Large capacity memory
9 Second accelerator
10 Data cache unit
11 Command interpretation unit
12 Data cache control unit
13 Data read unit
14 Data write unit
15 Refill control unit
16 Command response unit
30 Data cache unit
32 Data cache control unit
91 Determination unit
92 Transmission unit
93 Second table storage unit
94 Second management table
95 Management unit
100 Information processing apparatus
101 Data cache apparatus
102 In-memory information processing apparatus (database management apparatus)
103 Communication I/F
121 Management table control unit
122 Data control unit
123 Table storage unit
124 Management table
200 Information processing apparatus
201 Data cache apparatus
321 Management table control unit
323 Small capacity memory
324 Management table
300 Information processing apparatus
301 Data cache apparatus
302 Data cache control unit
303 Cache memory
400 Information processing apparatus
401 Data cache apparatus
#10 Write request
#15 Write response
#20 Read request
#25 Read response

What is claimed is:

1. An information processing apparatus comprising:
a data cache apparatus including a cache memory; and
a management apparatus including a large capacity memory whose capacity is larger than that of the cache memory,
wherein the data cache apparatus includes a data cache control unit configured to control data in a predetermined condition stored in the cache memory to be located in the large capacity memory when a read request or a write request is received from outside the information processing apparatus, and
wherein when the received request is a write request, the data cache control unit writes data to be written to the cache memory in accordance with the write request, and when the request is a read request, the data cache control unit writes data read in accordance with the read request to the cache memory.

2. The information processing apparatus according to claim 1,
wherein the data cache control unit
confirms whether data corresponding to the received request is present in the cache memory or not,
when data corresponding to the request is present in the cache memory, reads data or writes data from/to the cache memory in accordance with the request, and
when data corresponding to the request is not present in the cache memory, controls the data in a predetermined condition to be located in the large capacity memory and writes the data to be written or data read in accordance with the read request to the cache memory.

3. The information processing apparatus according to claim 2,
wherein the data cache control unit,
when data corresponding to the request is not present in the cache memory, further confirms whether there is a free space whose size is not smaller than the data length of the data to be written or data to be read in the read request or not,
when there is a free space whose size is not smaller than the data length in the cache memory, writes data read from the large capacity memory to the free space of the cache memory in accordance with the data to be written or the read request, and
when there is not a free space whose size is not smaller than the data length of the cache memory in the cache memory, controls the data in a predetermined condition to be located in the large capacity memory, and further, writes the data to be written or data read in accordance with the read request to the cache memory.

4. The information processing apparatus according to claim 2,
wherein the data cache control unit includes a management table control unit configured to control a management table for managing information about data stored in the cache memory,
wherein the management table includes, as information about the data, an identifier representing data, a data length of the data, a head address of the data in the cache memory, and
wherein the management table control unit confirms whether data corresponding to the received request is present in the cache memory or not by referring to the management table.

5. The information processing apparatus according to claim 4, wherein the management table control unit manages state information representing a state of the data by associating with information about the data.

6. The information processing apparatus according to claim 5, wherein the management table control unit updates the state information when the data cache control unit controls the data in a predetermined condition to be located in the large capacity memory and writes the data to be written or data read in accordance with the read request to the cache memory.

7. The information processing apparatus according to claim 5, wherein the data in a predetermined condition is data in which the state information is information representing that the data is in an invalid state.

8. The information processing apparatus according to claim 1 wherein the data in a predetermined condition is data in which a reference degree is lower.

9. The information processing apparatus according to claim 8, wherein the data in which a reference degree is lower is data whose last reference date and time is the oldest.

10. The information processing apparatus according to claim 4,
wherein the cache memory is included in the data cache control unit,
wherein the cache memory stores the management table, and
wherein the management table includes a data body of the data as information about the data.

11. The information processing apparatus according to claim 1 wherein the data cache apparatus comprises:
a data presence determination unit configured to determine, when a read request or a write request is received from outside the information processing apparatus, whether data corresponding to the received request is stored in the management apparatus or not; and
a transmission unit configured to transmit a response to another apparatus when the data is not stored in the management apparatus,
wherein the transmission unit terminates a process in the data cache apparatus for the request.

12. The information processing apparatus according to claim 11, wherein the transmission unit transmits a response representing that data corresponding to the request is not stored in the management apparatus to a transmission destination of the request.

13. The information processing apparatus according to claim 11,
wherein the data cache apparatus further comprises a management unit configured to manage information representing data stored in the management apparatus connected to the data cache apparatus and another management apparatus included in each of one or a plurality of other information processing apparatuses connected to the data cache apparatus via a network,
wherein, when data corresponding to the request is stored in the another management apparatus, the transmission unit transmits the received request to another information processing apparatus including the the another management apparatus.

14. The information processing apparatus according to claim 1,
wherein the data cache apparatus further comprises:
a determination unit configured to receive a read request or a write request from outside the information processing apparatus, and determine whether the received read request or the received write request is a request which is processed by the data cache apparatus or not; and
a refill control unit configured to transmit the read request or the write request to the management apparatus, and receive a read response or a write response corresponding to the read request or the write request, respectively,
wherein the determination unit provides the read request or the write request to the refill control unit when the received read request or the received write request is determined not to be a request which is processed in the data cache apparatus, and provides the read request or the write request to the data cache control unit when the received read request or the received write request is determined to be a request which is processed in the data cache apparatus.

15. A data cache apparatus which includes a cache memory, and which is connected to a management apparatus including a large capacity memory whose capacity is larger than that of the cache memory, the data cache apparatus comprising
a data cache control unit configured to control data in a predetermined condition stored in the cache memory to be located in the large capacity memory when a read request or a write request is received from outside the data cache apparatus and the management apparatus,
wherein when the received request is a write request, the data cache control unit writes data to be written to the cache memory in accordance with the write request, and when the request is a read request, the data cache control unit writes data read in accordance with the read request to the cache memory.

16. An information processing method of an information processing apparatus comprising a data cache apparatus including a cache memory and a management apparatus including a large capacity memory whose capacity is larger than that of the cache memory, the method comprising:
receiving a read request or a write request from outside the information processing apparatus;
when the received request is a write request, controlling data in a predetermined condition stored in the cache memory to be located in the large capacity memory and further writing data to be written to the cache memory in accordance with the write request; and
when the received request is a read request, controlling the data in the predetermined condition to be located in the large capacity memory and further writing data read in accordance with the read request to the cache memory.

17. (canceled)
